(19) United States
(12) Patent Application Publication
(10) Pub. No.: US 2025/0108323 A1
(43) Pub. Date: Apr. 3, 2025

(54) HVAC SYSTEM WITH AIR FILTRATION ESTIMATION AND CONTROL

(71) Applicant: Tyco Fire & Security GmbH, Neuhausen am Rheinfall (CH)

(72) Inventors: MICHAEL J. WENZEL, Grafton, WI (US); FANG DU, Milwaukee, WI (US); ANAS W. I. ALANQAR, Milwaukee, WI (US); JONATHAN D. DOUGLAS, Mequon, WI (US)

(73) Assignee: Tyco Fire & Security GmbH, Neuhausen am Rheinfall (CH)

(21) Appl. No.: 18/900,589

(22) Filed: Sep. 27, 2024

Related U.S. Application Data
(60) Provisional application No. 63/586,515, filed on Sep. 29, 2023.

(51) Int. Cl. B01D 46/46; B01D 46/44; F24F 8/108; F24F 11/70

(52) U.S. Cl. CPC B01D 46/46; B01D 46/442; F24F 8/108; F24F 11/70; B01D 2279/50

(57) ABSTRACT

An HVAC controller includes one or more processors and one or more non-transitory computer-readable media storing instructions that, when executed by the one or more processors, cause the one or more processors to perform operations comprising determining a filtration efficiency of an air filter located within an air handling unit and positioned to filter a pollutant from an airstream provided to a building zone by the air handling unit, determining an internal generation rate of the pollutant within the building zone, and initiating an automated action based on the filtration efficiency of the air filter within the air handling unit and the internal generation rate of the pollutant within the building zone.

### CROSS-REFERENCE TO RELATED PATENT APPLICATIONS

This application claims the benefit of U.S. Provisional Patent Application No. 63/586,515 filed Sep. 29, 2023, the entire contents of which is incorporated herein by reference.

### BACKGROUND

The present disclosure relates generally to HVAC systems for a building and air handling units (AHUs) in a building HVAC system. Economizers are one type of AHU in a building HVAC system that provide ventilation to a building space. Economizers are capable of both recirculating air from the building space and introducing outside air into the building space by varying an amount of outside air permitted to pass through the economizer.

Indoor air quality (IAQ) is an important attribute of an indoor space and has a significant impact on humans. Reducing exposure to indoor air with threatening pollutants can lead to a higher quality of life and a lower risk of respiratory and other illnesses. IAQ can be improved in a variety of ways including increasing ventilation, effective HVAC air filtration, and disinfection. In some situations, increasing ventilation does not improve IAQ. For example, when outside air quality is low (e.g., due to outdoor pollutants, allergens, etc.) increasing the rate at which outdoor air is ventilated into the building may negatively affect IAQ. In this scenario, air filtration plays a significant role.

Effective HVAC air filtration within an AHU can help reduce air pollution (e.g., dust, allergens, particulate matter, etc.) and increase IAQ by filtering the air stream provided from the AHU to a building zone. However, when air pollution is generated within the building zone, air filtration within the AHU has limited effectiveness and additional in-zone air filtration may be needed to improve IAQ to desired levels. Accordingly, identifying the factors that contribute most significantly to low IAQ may help inform the most effective corrective measure.

### SUMMARY

One implementation of the present disclosure is a building system including one or more processors and one or more non-transitory computer-readable media storing instructions that, when executed by the one or more processors, cause the one or more processors to perform operations including determining a filtration efficiency of an air filter located within an air handling unit and positioned to filter a pollutant from an airstream provided to a building zone by the air handling unit, determining an internal generation rate of the pollutant within the building zone, and initiating an automated action based on the filtration efficiency of the air filter within the air handling unit and the internal generation rate of the pollutant within the building zone.

In some embodiments, determining the filtration efficiency of the air filter within the air handling unit includes obtaining a first ratio of outdoor air pollutant concentration outside the building to indoor air pollutant concentration within the building zone; obtaining a second ratio of recirculation air flow rate from the building zone to outdoor air flow rate from outside the building; and using the first ratio and the second ratio to calculate the filtration efficiency of the air filter.

In some embodiments, determining the filtration efficiency of the air filter within the air handling unit includes calculating a weighted average of values of the filtration efficiency for a number of time steps.

In some embodiments, calculating the weighted average of the values of the filtration efficiency includes determining values of uncertainty corresponding to the values of the filtration efficiency at the number of time steps and assigning weights to the values of the filtration efficiency in the weighted average based on the corresponding values of the uncertainty at the number of time steps.

In some embodiments, determining the internal generation rate of the pollutant within the building zone includes calculating a pollutant generation time ratio based on a plurality of values of the internal generation rate of the pollutant within the building zone at a number of time steps.

In some embodiments, calculating the pollutant generation time ratio includes determining at least one of a percentage of the pollutant generated within the building zone during occupied time periods or an average amount of the pollutant generated within the building zone during occupied time periods.

In some embodiments, the automated action includes causing or recommending an upgrade to the air filter within the air handling unit in response to determining that the filtration efficiency of the air filter is below a first threshold and the internal generation rate of the pollutant within the building zone is below a second threshold.

In some embodiments, the automated action includes activating or recommending the activation of in-zone filtration within the building zone in response to determining that the filtration efficiency of the air filter is above a first threshold and the internal generation rate of the pollutant within the building zone is above a second threshold.

In some embodiments, the automated action includes both activating or recommending the activation of in-zone filtration within the building zone and causing or recommending an upgrade to the air filter within the air handling unit in response to determining that the filtration efficiency of the air filter is below a first threshold and the internal generation rate of the pollutant within the building zone is above a second threshold.

In some embodiments, the automated action includes informing a user that no action is needed in response to determining that the filtration efficiency of the air filter is above a first threshold and the internal generation rate of the pollutant within the building zone is below a second threshold.

Another implementation of the present disclosure is a method for operating air filtration equipment including determining a filtration efficiency of an air filter located within an air handling unit and positioned to filter a pollutant from an airstream provided to a building zone by the air handling unit, determining an internal generation rate of the pollutant within the building zone, and initiating an automated action based on the filtration efficiency of the air filter within the air handling unit and the internal generation rate of the pollutant within the building zone.

In some embodiments, determining the filtration efficiency of the air filter within the air handling unit includes obtaining a first ratio of outdoor air pollutant concentration outside the building to indoor air pollutant concentration within the building zone; obtaining a second ratio of recirculation air flow rate from the building zone to outdoor air flow rate from outside the building; and using the first ratio and the second ratio to calculate the filtration efficiency of the air filter.

In some embodiments, determining the filtration efficiency of the air filter within the air handling unit includes calculating a weighted average of values of the filtration efficiency for a number of time steps.

In some embodiments, calculating the weighted average of the values of the filtration efficiency includes determining values of uncertainty corresponding to the values of the filtration efficiency at the number of time steps and assigning weights to the values of the filtration efficiency in the weighted average based on the corresponding values of the uncertainty at the number of time steps.

In some embodiments, determining the internal generation rate of the pollutant within the building zone includes calculating a pollutant generation time ratio based on values of the internal generation rate of the pollutant within the building zone at a number of time steps.

In some embodiments, calculating the pollutant generation time ratio includes determining at least one of a percentage of the pollutant generated within the building zone during occupied time periods or an average amount of the pollutant generated within the building zone during occupied time periods.

In some embodiments, the automated action includes causing or recommending an upgrade to the air filter within the air handling unit in response to determining that the filtration efficiency of the air filter is below a first threshold and the internal generation rate of the pollutant within the building zone is below a second threshold.

In some embodiments, the automated action includes activating or recommending the activation of in-zone filtration within the building zone in response to determining that the filtration efficiency of the air filter is above a first threshold and the internal generation rate of the pollutant within the building zone is above a second threshold.

In some embodiments, the automated action includes both activating or recommending the activation of in-zone filtration within the building zone and causing or recommending an upgrade to the air filter within the air handling unit in response to determining that the filtration efficiency of the air filter is below a first threshold and the internal generation rate of the pollutant within the building zone is above a second threshold.

In some embodiments, the automated action includes informing a user that no action is needed in response to determining that the filtration efficiency of the air filter is above a first threshold and the internal generation rate of the pollutant within the building zone is below a second threshold.

Another implementation of the present disclosure is one or more processors and one or more non-transitory computer-readable media storing instructions that, when executed by the one or more processors, cause the one or more processors to perform operations. The operations include acquiring a measurement of a pollutant from outside a building and a measurement of the pollutant from inside the building. The operations also include determining a filtration efficiency of an air filter positioned to filter the pollutant from an airstream provided to the building based at least on the ratio between the measurement of the pollutant from outside the building and the measurement of the pollutant from inside the building. The operations also include determining the filtration efficiency and a level of uncertainty in the filtration efficiency for a number of time periods. The operations also include determining a weighted average of the filtration efficiency. Weights of the weighted average depend at least on the level of uncertainty of a respective filtration efficiency. The operations also include initiating an automated action based on the weighted average of the filtration efficiency of the air filter within the building zone.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a perspective view of a building including a heating, ventilating, or air conditioning (HVAC) system, according to some embodiments.

FIG. 2 is a block diagram of an airside system including an air handling unit (AHU) which can be used in the HVAC system of FIG. 1, according to some embodiments.

FIG. 3 is a block diagram of an AHU controller which can be used to monitor and control the AHU of FIG. 2, according to some embodiments.

FIG. 4 is a block diagram of an AHU with air filtration, according to some embodiments.

FIG. 5 is a three-dimensional graph of air filtration efficiency as a function of the pollutant ratio, according to some embodiments.

FIG. 6 is a two-dimensional graph of air filtration efficiency as a function of the pollutant ratio, according to some embodiments.

FIG. 7 is a graph illustrating the results of testing conducted to verify the correctness of the effective filter efficiency calculations, according to some embodiments.

FIG. 8 is another graph illustrating the results of testing conducted to verify the correctness of the effective filter efficiency calculations, according to some embodiments.

FIG. 9 is another graph illustrating the results of testing conducted to verify the correctness of the effective filter efficiency calculations, according to some embodiments.

FIG. 10 is another graph illustrating the results of testing conducted to verify the correctness of the effective filter efficiency calculations, according to some embodiments.

FIG. 11 is a graph illustrating techniques for detecting internal pollutant generation within a building zone, according to some embodiments.

FIG. 12 is another graph illustrating techniques for detecting internal pollutant generation within a building zone, according to some embodiments.

FIG. 13 is another graph illustrating techniques for detecting internal pollutant generation within a building zone, according to some embodiments.

FIG. 14 is a graph illustrating techniques for determining internal pollutant generation ratios, according to some embodiments.

FIG. 15 is a graph illustrating various actions which can be suggested or implemented by the AHU controller as a result of the air filtration efficiency and pollutant generation calculations, according to some embodiments.

FIG. 16 is another graph illustrating various actions which can be suggested or implemented by the AHU controller as a result of the air filtration efficiency and pollutant generation calculations, according to some embodiments.

FIG. 17 is a flow of operations for initiating an automated action based on a filtration efficiency of an air filter and an internal generation rate of a pollutant within a building zone, according to some embodiments.

FIG. 18 is a flow of operations for determining the automated action based on a filtration efficiency of an air filter and an internal generation rate of a pollutant within a building zone, according to some embodiments.

FIG. 19 is a flow of operations for estimating a filter efficiency and initiating an automated action based on the efficiency, according to some embodiments.

FIG. 20 is a flow of operations for identifying time periods of significant indoor pollutant generation and initiating an automated action based on the time periods of generation, according to some embodiments.

### DETAILED DESCRIPTION

### Building HVAC System

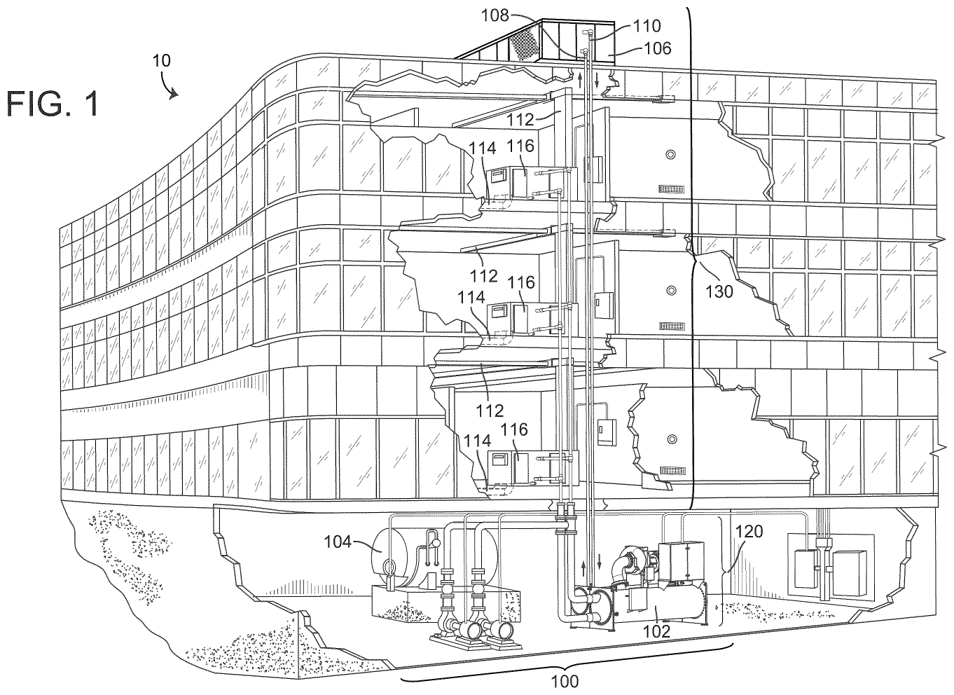

Referring now to FIG. 1, a perspective view of a building 10 is shown. Building 10 is served by a heating, ventilating, or air conditioning (HVAC) system 100. HVAC system 100 can include a plurality of HVAC devices (e.g., heaters, chillers, air handling units, pumps, fans, thermal energy storage, etc.) configured to provide heating, cooling, air conditioning, ventilation, and/or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.) that serves one or more buildings including building 10. The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Airside System

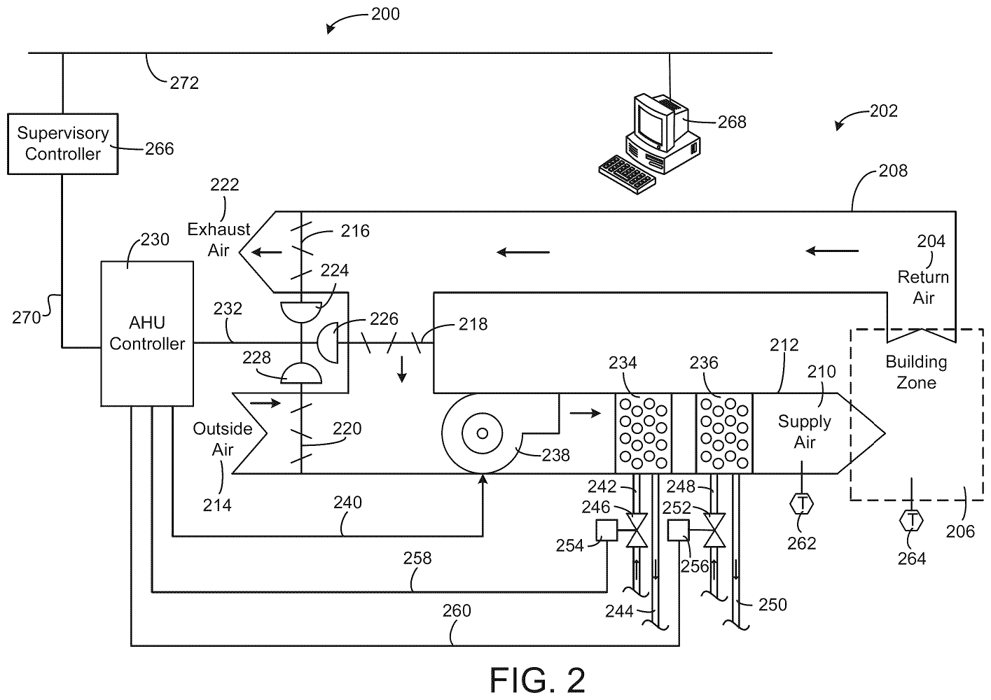

Referring now to FIG. 2, a block diagram of an airside system 200 is shown, according to some embodiments. In various embodiments, airside system 200 may supplement or replace airside system 130 in HVAC system 100 or can be implemented separate from HVAC system 100. When implemented in HVAC system 100, airside system 200 can include a subset of the HVAC devices in HVAC system 100 (e.g., AHU 106, VAV units 116, ducts 112-114, fans, dampers, etc.) and can be located in or around building 10. Airside system 200 may operate to heat or cool an airflow provided to building 10 using a heated or chilled fluid provided by waterside system 120.

In FIG. 2, airside system 200 is shown to include an economizer-type air handling unit (AHU) 202. Economizer-type AHUs vary the amount of outside air and return air used by the air handling unit for heating or cooling. For example, AHU 202 may receive return air 204 from building zone 206 via return air duct 208 and may deliver supply air 210 to building zone 206 via supply air duct 212. In some embodiments, AHU 202 is a rooftop unit located on the roof of building 10 (e.g., AHU 106 as shown in FIG. 1) or otherwise positioned to receive both return air 204 and outside air 214. AHU 202 can be configured to operate exhaust air damper 216, mixing damper 218, and outside air damper 220 to control an amount of outside air 214 and return air 204 that combine to form supply air 210. Any return air 204 that does not pass through mixing damper 218 can be exhausted from AHU 202 through exhaust air damper 216 as exhaust air 222.

Each of dampers 216-220 can be operated by an actuator. For example, exhaust air damper 216 can be operated by actuator 224, mixing damper 218 can be operated by actuator 226, and outside air damper 220 can be operated by actuator 228. Actuators 224-228 may communicate with an AHU controller 230 via a communications link 232. Actuators 224-228 may receive control signals from AHU controller 230 and may provide feedback signals to AHU controller 230. Feedback signals can include, for example, an indication of a current actuator or damper position, an amount of torque or force exerted by the actuator, diagnostic information (e.g., results of diagnostic tests performed by actuators 224-228), status information, commissioning information, configuration settings, calibration data, and/or other types of information or data that can be collected, stored, or used by actuators 224-228. AHU controller 230 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 224-228.

Still referring to FIG. 2, AHU 202 is shown to include a cooling coil 234, a heating coil 236, and a fan 238 positioned within supply air duct 212. Fan 238 can be configured to force supply air 210 through cooling coil 234 and/or heating coil 236 and provide supply air 210 to building zone 206. AHU controller 230 may communicate with fan 238 via communications link 240 to control a flow rate of supply air 210. In some embodiments, AHU controller 230 controls an amount of heating or cooling applied to supply air 210 by modulating a speed of fan 238.

Cooling coil 234 may receive a chilled fluid from waterside system 120 (via piping 242 and may return the chilled fluid to waterside system 120 via piping 244. Valve 246 can be positioned along piping 242 or piping 244 to control a flow rate of the chilled fluid through cooling coil 234. In some embodiments, cooling coil 234 includes multiple stages of cooling coils that can be independently activated and deactivated (e.g., by AHU controller 230, by supervisory controller 266, etc.) to modulate an amount of cooling applied to supply air 210.

Heating coil 236 may receive a heated fluid from waterside system 120 via piping 248 and may return the heated fluid to waterside system 120 via piping 250. Valve 252 can be positioned along piping 248 or piping 250 to control a flow rate of the heated fluid through heating coil 236. In some embodiments, heating coil 236 includes multiple stages of heating coils that can be independently activated and deactivated (e.g., by AHU controller 230, by supervisory controller 266, etc.) to modulate an amount of heating applied to supply air 210.

Each of valves 246 and 252 can be controlled by an actuator. For example, valve 246 can be controlled by actuator 254 and valve 252 can be controlled by actuator 256. Actuators 254-256 may communicate with AHU controller 230 via communications links 258-260. Actuators 254-256 may receive control signals from AHU controller 230 and may provide feedback signals to controller 230. In some embodiments, AHU controller 230 receives a measurement of the supply air temperature from a temperature sensor 262 positioned in supply air duct 212 (e.g., downstream of cooling coil 234 and/or heating coil 236). AHU controller 230 may also receive a measurement of the temperature of building zone 206 from a temperature sensor 264 located in building zone 206.

In some embodiments, AHU controller 230 operates valves 246 and 252 via actuators 254-256 to modulate an amount of heating or cooling provided to supply air 210 (e.g., to achieve a setpoint temperature for supply air 210 or to maintain the temperature of supply air 210 within a setpoint temperature range). The positions of valves 246 and 252 affect the amount of heating or cooling provided to supply air 210 by cooling coil 234 or heating coil 236 and may correlate with the amount of energy consumed to achieve a desired supply air temperature. AHU controller 230 may control the temperature of supply air 210 and/or building zone 206 by activating or deactivating coils 234-236, adjusting a speed of fan 238, or a combination of both.

Still referring to FIG. 2, airside system 200 is shown to include a supervisory controller 266 and a client device 268. Supervisory controller 266 can include one or more computer systems (e.g., servers, supervisory controllers, subsystem controllers, etc.) that serve as system level controllers, application or data servers, head nodes, or master controllers for airside system 200, waterside system 120, HVAC system 100, and/or other controllable systems that serve building 10. Supervisory controller 266 may communicate with multiple downstream building systems or subsystems (e.g., HVAC system 100, a security system, a lighting system, waterside system 120, etc.) via a communications link 270 according to like or disparate protocols (e.g., LON, BACnet, etc.). In various embodiments, AHU controller 230 and supervisory controller 266 can be separate (as shown in FIG. 2) or integrated. In an integrated implementation, AHU controller 230 can be a software module configured for execution by a processor of supervisory controller 266.

In some embodiments, AHU controller 230 receives information from supervisory controller 266 (e.g., commands, setpoints, operating boundaries, etc.) and provides information to supervisory controller 266 (e.g., temperature measurements, valve or actuator positions, operating statuses, diagnostics, etc.). For example, AHU controller 230 may provide supervisory controller 266 with temperature measurements from temperature sensors 262-264, equipment on/off states, equipment operating capacities, and/or any other information that can be used by supervisory controller 266 to monitor or control a variable state or condition within building zone 206.

Client device 268 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 268 can be a computer workstation, a client terminal, a remote or local interface, or any other type of user interface device. Client device 268 can be a stationary terminal or a mobile device. For example, client device 268 can be a desktop computer, a computer server with a user interface, a laptop computer, a tablet, a smartphone, a PDA, or any other type of mobile or non-mobile device. Client device 268 may communicate with supervisory controller 266 and/or AHU controller 230 via communications link 270.

In some embodiments, communications link 270 may be a network that provides access to remote computers and/or a cloud compute infrastructure operating as a remote analysis system to perform additional analysis and/or to store data. Data from AHU controller 230 may be communicated over network 272 for storage and use in analysis. Data (e.g., analysis results, actions, etc.) may be communicated back to AHU controller 230 or any other devices connected to network 272. The remote analysis system may include a processing circuit having one or more processors and memory. The one or more processors may be a general purpose or specific purpose processor, an application specific integrated circuit (ASIC), one or more field programmable gate arrays (FPGAs), a group of processing components, or other suitable processing components. The one or more processors is configured to execute computer code or instructions stored in memory or received from other computer readable media (e.g., CDROM, network storage, a remote server, etc.). The memory may include one or more devices (e.g., memory units, memory devices, storage devices, etc.) for storing data and/or computer code for completing and/or facilitating the various processes described in the present disclosure. The memory of the remote analysis system may include random access memory (RAM), read-only memory (ROM), hard drive storage, temporary storage, non-volatile memory, flash memory, optical memory, or any other suitable memory for storing software objects and/or computer instructions. The memory may include database components, object code components, script components, or any other type of information structure for supporting the various activities and information structures described in the present disclosure. Memory may be communicably connected to processor via processing circuit and may include computer code for executing (e.g., by the processor) one or more processes described herein.

### AHU Controller

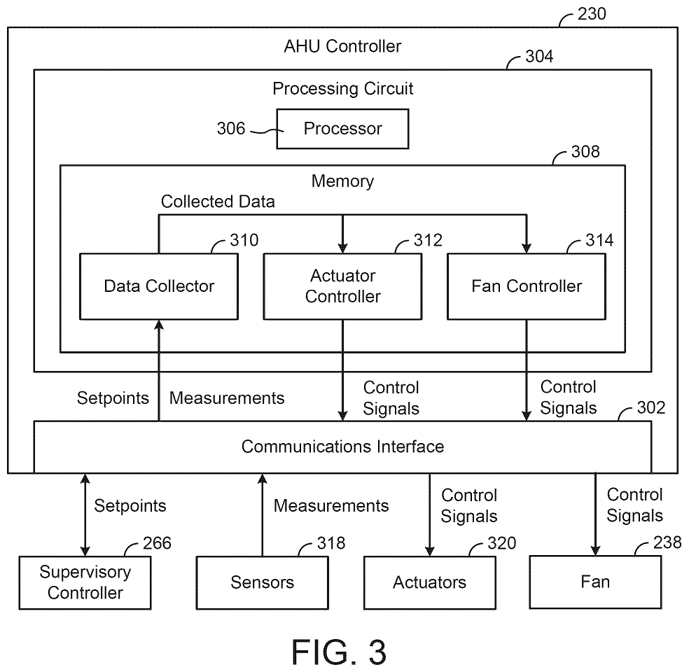

Referring now to FIG. 3, a block diagram illustrating AHU controller 230 in greater detail is shown, according to an exemplary embodiment. AHU controller 230 may be configured to monitor and control various components of AHU 202 using any of a variety of control techniques (e.g., state-based control, on/off control, proportional control, proportional-integral (PI) control, proportional-integral-derivative (PID) control, extremum seeking control (ESC), model predictive control (MPC), etc.). AHU controller 230 may receive setpoints from supervisory controller 266 and measurements from sensors 318 and may provide control signals to actuators 320 and fan 238.

Sensors 318 may include any of the sensors shown in FIG. 2 or any other sensor configured to monitor any of a variety of variables used by AHU controller 230. Variables monitored by sensors 318 may include, for example, zone air temperature, zone air humidity, zone occupancy, zone CO2 levels, zone particulate matter (PM) levels, outdoor air temperature, outdoor air humidity, outdoor air CO2 levels, outdoor air PM levels, damper positions, valve positions, fan status, supply air temperature, supply air flowrate, or any other variable of interest to AHU controller 230.

Actuators 320 may include any of the actuators shown in FIG. 2 or any other actuator controllable by AHU controller 230. For example, actuators 320 may include actuator 224 configured to operate exhaust air damper 216, actuator 226 configured to operate mixing damper 218, actuator 228 configured to outside air damper 220, actuator 254 configured to operate valve 246, and actuator 256 configured to operate valve 252. Actuators 320 may receive control signals from AHU controller 230 and may provide feedback signals to AHU controller 230.

AHU controller 230 may control AHU 202 by controllably changing and outputting control signals provided to actuators 320 and fan 238. In some embodiments, the control signals include commands for actuators 320 to set dampers 216-220 and/or valves 246 and 252 to specific positions to achieve a target value for a variable of interest (e.g., supply air temperature, supply air humidity, flow rate, etc.). In some embodiments, the control signals include commands for fan 238 to operate a specific operating speed or to achieve a specific airflow rate. The control signals may be provided to actuators 320 and fan 238 via communications interface 302. AHU 202 may use the control signals an input to adjust the positions of dampers 216-220 control the relative proportions of outside air 214 and return air 204 provided to building zone 206.

AHU controller 230 may receive various inputs via communications interface 302. Inputs received by AHU controller 230 may include setpoints from supervisory controller 266, measurements from sensors 318, a measured or observed position of dampers 216-220 or valves 246 and 252, a measured or calculated amount of power consumption, an observed fan speed, temperature, humidity, air quality, or any other variable that can be measured or calculated in or around building 10.

AHU controller 230 includes logic that adjusts the control signals to achieve a target outcome. In some operating modes, the control logic implemented by AHU controller 230 utilizes feedback of an output variable. The logic implemented by AHU controller 230 may also or alternatively vary a manipulated variable based on a received input signal (e.g., a setpoint). Such a setpoint may be received from a user control (e.g., a thermostat), a supervisory controller (e.g., supervisory controller 266), or another upstream device via a communications network (e.g., a BACnet network, a LonWorks network, a LAN, a WAN, the Internet, a cellular network, etc.).

Still referring to FIG. 3, AHU controller 230 is shown to include a communications interface 302. Communications interface 302 can be or include wired or wireless communications interfaces (e.g., jacks, antennas, transmitters, receivers, transceivers, wire terminals, etc.) for conducting data communications with various components of AHU 202 or other external systems or devices. In various embodiments, communications via communications interface 302 can be direct (e.g., local wired or wireless communications) or via a communications network (e.g., a WAN, the Internet, a cellular network, etc.). For example, communications interface 302 can include an Ethernet card and port for sending and receiving data via an Ethernet-based communications link or network. In another example, communications interface 302 can include a Wi-Fi transceiver for communicating via a wireless communications network. In another example, communications interface 302 can include a cellular or mobile phone transceiver, a power line communications interface, an Ethernet interface, or any other type of communications interface.

Still referring to FIG. 3, AHU controller 230 is shown to include a processing circuit 304 having one or more processors 306 and memory 308. The one or more processors 306 may be a general purpose or specific purpose processor, an application specific integrated circuit (ASIC), one or more field programmable gate arrays (FPGAs), a group of processing components, or other suitable processing components. The one or more processors 306 is configured to execute computer code or instructions stored in memory 308 or received from other computer readable media (e.g., CDROM, network storage, a remote server, etc.).

Memory 308 may include one or more devices (e.g., memory units, memory devices, storage devices, etc.) for storing data and/or computer code for completing and/or facilitating the various processes described in the present disclosure. Memory 308 may include random access memory (RAM), read-only memory (ROM), hard drive storage, temporary storage, non-volatile memory, flash memory, optical memory, or any other suitable memory for storing software objects and/or computer instructions. Memory 308 may include database components, object code components, script components, or any other type of information structure for supporting the various activities and information structures described in the present disclosure. Memory 308 may be communicably connected to processor 306 via processing circuit 304 and may include computer code for executing (e.g., by processor 306) one or more processes described herein.

Memory 308 can include any of a variety of functional components (e.g., stored instructions or programs) that provide AHU controller 230 with the ability to monitor and control AHU 202. For example, memory 308 is shown to include a data collector 310 which operates to collect the data received via communications interface 302 (e.g., setpoints, measurements, feedback from actuators 320 and fan 238, etc.). Data collector 310 may provide the collected data to actuator controller 312 and fan controller 314 which use the collected data to generate control signals for actuators 320 and fan 238, respectively. The particular type of control methodology used by actuator controller 312 and fan controller 314 (e.g., state-based control, PI control, PID control, ESC, MPC, etc.) may vary depending on the configuration of AHU controller and can be adapted for various implementations.

AHU with Air Filtration

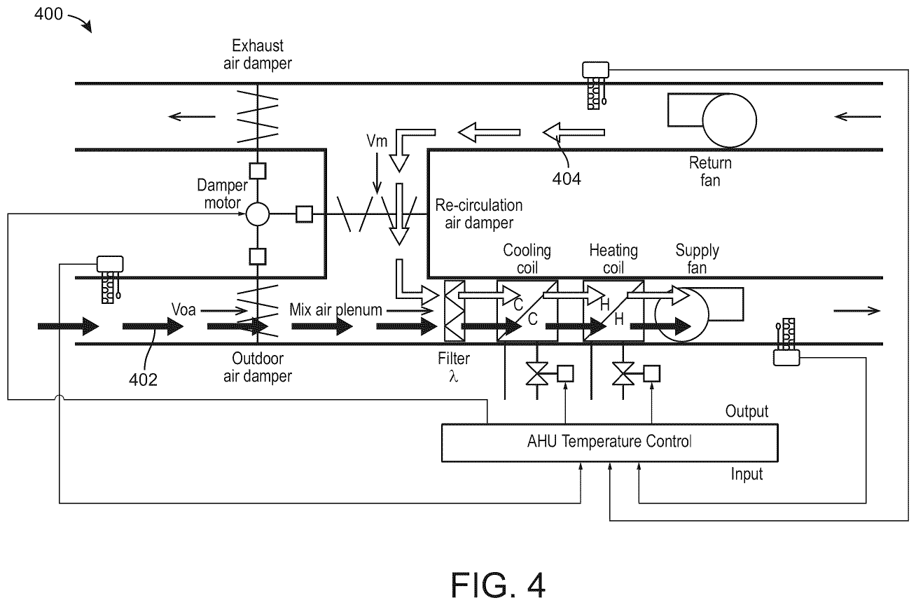

Referring now to FIG. 4, an AHU 400 with air filtration is shown, according to an exemplary embodiment. Effective HVAC air filtration within AHU 400 can help reduce air pollution (e.g., dust, allergens, particulate matter, etc.) and increase indoor air quality (IAQ) by filtering the air stream provided from AHU 400 to a building zone. However, when air pollution is generated within the building zone, air filtration within AHU 400 has limited effectiveness and additional in-zone air filtration may be needed to improve IAQ to desired levels. Accordingly, identifying the factors that contribute most significantly to low IAQ may help inform the most effective corrective measure. For example, if the primary cause of low IAQ is pollution generation within the building zone, installing or activating in-zone air filtration may significantly improve IAQ. However, if the most significant cause of low IAQ is poor outdoor air quality or poor air filtration efficiency within AHU 400, upgrading or replacing the air filter within AHU 400 may significantly improve IAQ.

IAQ can be measured or quantified in a variety of ways. One measure of IAQ is particulate matter (PM) concentration within the air, for example, as defined by the PM2.5 standard. The indoor PM2.5 concentration can be measured by a suitable sensor, such as the exemplary sensor described in the table below. In this table, “MV” stands for a measurement value. Throughout the present disclosure, PM2.5 concentration is used to describe air pollutants and serves as a measure of air quality which can be used to execute the systems and methods described herein. However, it is contemplated that any other air quality metric could be used in addition to or in place of PM2.5 concentration (e.g., CO2 levels, nitrogen dioxide levels, ozone levels, sulfur dioxide levels, lead levels, PM10 levels, allergen levels, smoke levels, infectious disease concentration, etc.) without departing from the teachings of the present disclosure. It is also contemplated that the filter used to remove the pollutant may have forms that depend on the type of pollutant without departing from the teachings of the present disclosure.

| CO2 Sensor Type | Laser scattering based on optical particle counter |
|---|---|
| Measure Range (MR) | 0-500 μg/m³ |
| Accuracy | Below 150 μg/m³: ± (5 μg/m³ + 15% MV) |
| | Above 150 μg/m³: ± (5 μg/m³ + 20% MV) |
| Sampling Rate | 2.5 minutes |

FIG. 4 illustrates two paths of PM2.5 flow. The outdoor air stream 402 represents bringing PM2.5 into the building zone from outside the building, whereas the recirculation air stream 404 represents the PM2.5 recirculation from within the building zone via a return air stream. Since the PM2.5 concentration has no change in the recirculation air stream 404 (i.e., both ends of the recirculation air stream 404 are the building zone), the filter doesn't have any effect. The rate of change of PM2.5 concentration within the building zone can be modeled as a function of (i) the rate at which PM2.5 is added to the building zone from the outdoor air stream 402, (ii) the rate at which PM2.5 is added to the building zone from the recirculation air stream 404, and (iii) the rate at which PM2.5 is generated internally within the building zone.

These factors can be represented in a filtration model for the building zone, as shown in equation 1:

$${\dot{φ}}_{PM 2.5 , z} = {\dot{\tilde{v}}}_{oa} ( ( 1 - {λ}_{HVAC} ) {φ}_{PM 2.5 , OA} - {φ}_{PM 2.5 , z} ) + {\dot{\tilde{v}}}_{m} ( ( 1 - {λ}_{HVAC} ) {φ}_{PM 2.5 , z} - {φ}_{PM 2.5 , z} ) + {\dot{φ}}_{PM 2.5 , dist} \qquad [ 1 ]$$

where \dot{φ}_{PM2.5,z} is the rate of change of the indoor PM2.5 concentration in μg/m³/hour, \dot{\tilde{v}}ₒₐ is the ventilation rate of the outdoor air stream 402 in air changes/hour, λ_{HVAC} is the HVAC filter efficiency (unitless), φ_{PM2.5,OA} is the outdoor PM2.5 concentration in μg/m³, φ_{PM2.5,z} is the indoor PM2.5 concentration in μg/m³, \dot{\tilde{v}}ₘ is the recirculation air flow rate of the recirculation air stream 404 in air changes/hour, and \dot{φ}_{PM2.5,dist} is the PM2.5 disturbance in μg/m³ (i.e., the rate at which PM2.5 is being generated within the building zone).

In some embodiments, the HVAC filter efficiency λ_{HVAC} is a normalized value (e.g., 0≤λ_{HVAC}≤1) where a value of λ_{HVAC}=1 represents perfect filter efficiency (i.e., the filter captures 100% of the PM2.5 from the air stream passing through it), whereas a value of λ_{HVAC}=0 represents a completely ineffective filter (i.e., the filter captures 0% of the PM2.5 from the air stream passing through it). The term (1−λ_{HVAC}) therefore represents the amount of PM2.5 that remains in the airstream after passing through the filter and is negatively correlated with the filter efficiency λ_{HVAC}. For example, a value of (1−λ_{HVAC})=0.8 may indicate that the air filter removes 20% of the PM2.5 from the airstream and leaves 80% of the PM2.5 in the airstream.

Equation 2 is a simplified version of equation 1 in continuous time.

$${\dot{φ}}_{PM 2.5 , z} = - ( {\dot{\tilde{v}}}_{oa} + {\dot{\tilde{v}}}_{m} {λ}_{HVAC} ) {φ}_{PM 2.5 , z} + {\dot{\tilde{v}}}_{oa} ( 1 - {λ}_{HVAC} ) {φ}_{PM 2.5 , OA} + {\dot{φ}}_{PM 2.5 , dist} \qquad [ 2 ]$$

Equation 3 is a discrete-time format converted from the continuous-time equation of equation 2 (e.g., using A as the time step of the discrete time format and n as the discrete-time index). The discrete-time formulation may be useful when performing calculations on a computer. For example, when determining the internal generation of PM2.5 (\dot{φ}_{PM2.5,dist}) as described herein.

$$\begin{matrix}( {\dot{\tilde{v}}}_{oa} + {\dot{\tilde{v}}}_{m} {λ}_{HVAC} ) {φ}_{PM 2.5 , z} [ n + 1 ] - {\dot{\tilde{v}}}_{oa} ( 1 - {λ}_{HVAC} ) {φ}_{PM 2.5 , OA} [ n ] - {\dot{φ}}_{PM 2.5 , dist} [ n ] \\ = {e}^{- ( {\dot{\tilde{v}}}_{oa} + {\dot{\tilde{v}}}_{m} {λ}_{HVAC} ) Δ} ( ( {\dot{\tilde{v}}}_{oa} + {\dot{\tilde{v}}}_{m} {λ}_{HVAC} ) {φ}_{PM 2.5 , z} [ n ] \\ - {\dot{\tilde{v}}}_{oa} ( 1 - {λ}_{HVAC} ) {φ}_{PM 2.5 , OA} [ n ] - {\dot{φ}}_{PM 2.5 , dist} [ n ] )\end{matrix} \qquad [ 3 ]$$

If the natural ventilation from sources other than AHU 400 (e.g., window leakage, airflow through doorways, etc.) and in-zone filtration are considered, equation 1 can be converted to equation 4 as follows:

$$\begin{matrix}{φ}_{PM 2.5 , z} = {\dot{\tilde{v}}}_{oa} ( ( 1 - {λ}_{HVAC} ) {φ}_{PM 2.5 , OA} + {φ}_{PM 2.5 , z} ) + {\dot{\tilde{v}}}_{m} ( ( 1 - {λ}_{HVAC} ) {φ}_{PM 2.5 , z} - {φ}_{PM 2.5 , z} ) \\ + {\dot{\tilde{v}}}_{n} ( {φ}_{PM 2.5 , OA} + {φ}_{PM 2.5 , z} ) \\ + {\dot{\tilde{v}}}_{f} ( ( 1 - {λ}_{f} ) {φ}_{PM 2.5 , z} - {φ}_{PM 2.5 , z} )\end{matrix} \qquad [ 4 ]$$

where \dot{φ}_{PM2.5,z} is the rate of change of the indoor PM2.5 concentration in μg/m³/hour, \dot{\tilde{v}}ₒₐ is the ventilation rate of the outdoor air stream 402 in air changes/hour, λ_{HVAC} is the HVAC filter efficiency (unitless), φ_{PM2.5,OA} is the outdoor PM2.5 concentration in μg/m³, φ_{PM2.5,z} is the indoor PM2.5 concentration in μg/m³, \dot{\tilde{v}}ₘ is the recirculation air flow rate of the recirculation air stream 404 in air changes/hour, \dot{φ}_{PM2.5,dist} is the PM2.5 disturbance in μg/m³, \dot{\tilde{v}}ₙ is the natural air flow rate into the building zone from sources other than AHU 400 (e.g., via window leakage) in air changes/hour, \dot{\tilde{v}}_{f} is the in-zone filter ventilation rate in air changes/hour, and λ_{f} is the in-zone filter efficiency (unitless).

From equation 2, assuming no PM2.5 disturbance (i.e., \dot{φ}_{PM2.5,dist}=0), the HVAC filtration efficiency λ_{HVAC} under steady-state conditions (i.e., when \dot{φ}_{PM2.5,z}=0) can be calculated as shown in equation 5 for scenarios with no natural ventilation or in-zone filtration:

$${λ}_{HVAC} = \frac{\frac{{φ}_{PM 2.5 , OA}}{{φ}_{PM 2.5 , z}} - 1}{\frac{{φ}_{PM 2.5 , OA}}{{φ}_{PM 2.5 , z}} + \frac{{\dot{\tilde{v}}}_{m}}{{\dot{\tilde{v}}}_{oa}}} \qquad [ 5 ]$$

However, if natural ventilation and in-zone filtration are considered, the HVAC filtration efficiency λ_{HVAC} under steady-state conditions (i.e., when φ_{PM2.5,z}=0) can be calculated as shown in equation 6:

$$\frac{{λ}_{HVAC}}{1 + \frac{{\dot{\tilde{v}}}_{m}}{{\dot{\tilde{v}}}_{oa}} - \frac{{λ}_{f} \frac{{\dot{\tilde{v}}}_{f}}{{\dot{\tilde{v}}}_{oa}}}{( \frac{{φ}_{PM 2.5 , OA}}{{φ}_{PM 2.5 , z}} - 1 )}} = \frac{\frac{{φ}_{PM 2.5 , OA}}{{φ}_{PM 2.5 , z}} - 1}{\frac{{φ}_{PM 2.5 , OA}}{{φ}_{PM 2.5 , z}} + \frac{{\dot{\tilde{v}}}_{m}}{{\dot{\tilde{v}}}_{oa}}} \qquad [ 6 ]$$

Notably, the right side of both equations 5 and 6 are the same. This term is referred to as “effective filter efficiency” λ_{eff} throughout the present disclosure and is defined as follows:

$${λ}_{eff} = \frac{\frac{{φ}_{PM 2.5 , OA}}{{φ}_{PM 2.5 , z}} - 1}{\frac{{φ}_{PM 2.5 , OA}}{{φ}_{PM 2.5 , z}} + \frac{{\dot{\tilde{v}}}_{m}}{{\dot{\tilde{v}}}_{oa}}} \qquad [ 7 ]$$

The effective filter efficiency λ_{eff} represents the filter efficiency of a hypothetical air filter at the location shown in FIG. 4 (i.e., in the mixed air stream within AHU 400) when the filtration model does not separately account for natural ventilation \dot{\tilde{v}}ₙ or in-zone filtration λ_{f}. For implementations where the natural ventilation rate \dot{\tilde{v}}ₙ and in-zone filtration λ_{f} are not present or their effects are negligible, the effective filter efficiency λ_{eff} may be equivalent to the actual filter efficiency λ_{HVAC} of the actual air filter within AHU 400. However, for implementations where the natural ventilation rate \dot{\tilde{v}}ₙ and in-zone filtration λ_{f} are present and their effects are non-negligible, the effective filter efficiency λ_{eff} may differ from the actual filter efficiency λ_{HVAC} of the actual air filter within AHU 400. Specifically, the effective filter efficiency λ_{eff} in the later scenario represents the performance of a hypothetical air filter within AHU 400 that would achieve the same net effect of (i) the actual air filter within AHU 400, (ii) the natural ventilation rate \dot{\tilde{v}}ₙ, and (iii) and in-zone filtration λ_{f} with respect to PM2.5 changes in the building zone when all three of these factors are attributed to the hypothetical air filter rather than accounting for them separately in the filtration model.

While the discussion herein describes AHU controller 230 as calculating the effective filter efficiency of the AHU, it is contemplated that either the AHU controller 230, the remote analysis system, or both could calculate the effective filter efficiency of the AHU. For example, the AHU controller 230 may perform some of the point-by-point calculations (e.g., calculations that depend only on current measurements) and communicate them to the remote analysis system to determine weighted averages based on uncertainty as described herein.

AHU controller 230 can be configured to calculate the effective filter efficiency λ_{eff} using timeseries values of the outdoor air PM2.5 concentration φ_{PM2.5,OA}, the indoor air PM2.5 concentration φ_{PM2.5,z}, the recirculation air flow rate \dot{\tilde{v}}ₘ, and the outdoor air ventilation rate \dot{\tilde{v}}ₒₐ. Values of these variables can be obtained at each time step (e.g., from sensors 318, from a remote weather service, from supervisory controller 266, etc.) and provided as inputs to equation 7 to calculate the effective filter efficiency λ_{eff} at each time step. Similarly, if the natural ventilation rate \dot{\tilde{v}}ₙ n and in-zone filtration λ_{f} are accounted for separately in the filtration model, AHU controller 230 can calculate the actual filter efficiency λ_{HVAC} using timeseries values of these variables in addition to the variables used to calculate the effective filter efficiency λ_{eff} using equation 6.

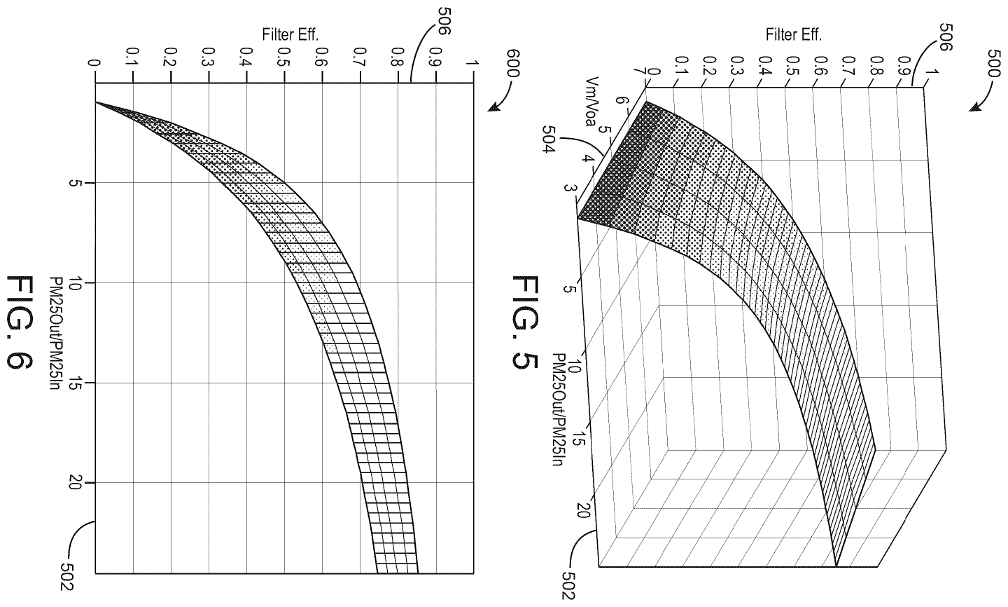

Referring now to FIGS. 5-6, a pair of curves 500 and 600 generated from equation 7 are shown. FIG. 5 illustrates a three-dimensional curve 500 wherein the x-axis 502 plots the ratio of the outdoor air PM2.5 concentration φ_{PM2.5,OA} over the indoor air PM2.5 concentration φ_{PM2.5,z} (i.e., φ_{PM2.5,OA}/φ_{PM2.5,z}), the y-axis plots the ratio of the recirculation air flow rate \dot{\tilde{v}}ₘ over the outdoor air flow rate \dot{\tilde{v}}ₒₐ (i.e., \dot{\tilde{v}}ₘ/\dot{\tilde{v}}ₒₐ), and the z-axis 506 plots the effective filter efficiency value λ_{eff}. FIG. 6 is a two-dimensional curve 600 representing a two-dimensional view of curve 500 with the y-axis removed. In curve 600, the x-axis 502 plots the ratio of the outdoor air PM2.5 concentration φ_{PM2.5,OA} over the indoor air PM2.5 concentration φ_{PM2.5,z} (i.e., φ_{PM2.5,OA}/φ_{PM2.5,z}) and the z-axis 506 plots the effective filter efficiency value λ_{eff}. From FIG. 6, the \dot{\tilde{v}}ₘ/\dot{\tilde{v}}ₒₐ ratio has a limited effect on effective filter efficiency λ_{eff}. For calculation simplification, the \dot{\tilde{v}}ₘ/\dot{\tilde{v}}ₒₐ ratio can be set to a constant number based on the expected air flow ratios of the AHU (e.g., four).

It is contemplated that the filter efficiency values change very slowly, and therefore the timeseries of filter efficiency values will not provide much useful information. To address this, AHU controller 230 can be configured to use a weighted average method to convert the timeseries of filter efficiency values to a single number. In various embodiments, the weighted average method may consider all of the timeseries values of the filter efficiency or predetermined number of the most recent timeseries values (e.g., a daily, weekly, or monthly moving average of the filter efficiency values).

In some embodiments, AHU controller 230 is configured to calculate the uncertainty of the effective filter efficiency λ_{eff}. Based on the concept of uncertainty propagation, the uncertainty of effective filter efficiency λ_{eff} can be expressed as shown in equation 8:

$$δ {λ}_{eff} = \sqrt{{( \frac{\partial {λ}_{eff}}{\partial {φ}_{PM 2.5 , O A}} \cdot {δφ}_{PM 2.5 , O A} )}^{2} + {( \frac{\partial {λ}_{eff}}{\partial {φ}_{PM 2.5 , z}} \cdot {δφ}_{PM 2.5 , z} )}^{2} + {( \frac{\partial {λ}_{eff}}{\partial {\dot{\tilde{v}}}_{m}} \cdot δ {\dot{\tilde{v}}}_{m} )}^{2} + {( \frac{\partial {λ}_{eff}}{\partial {\dot{\tilde{v}}}_{oa}} \cdot δ {\dot{\tilde{v}}}_{oa} )}^{2}} \qquad [ 8 ]$$

where δλ_{eff} is the uncertainty of effective filter efficiency (unitless), δφ_{PM2.5,OA} is the uncertainty of outdoor PM2.5 concentration in μg/m³, δφ_{PM2.5,z} is the uncertainty of indoor PM2.5 concentration in μg/m³, δ\dot{\tilde{v}}ₘ is the uncertainty of recirculation air change rate in air changes/hour, and δ\dot{\tilde{v}}ₒₐ is the uncertainty of ventilation rate in air changes/hour. Both δ\dot{\tilde{v}}ₘ and δ\dot{\tilde{v}}ₒₐ can be measured or estimated using models.

The expression shown in equation 8 can be simplified by assuming zero uncertainty for the outdoor air ventilation rate \dot{\tilde{v}}ₒₐ and recirculation rate \dot{\tilde{v}}ₘ. With these simplifications, the uncertainty of effective filter efficiency can be expressed as shown in equation 9:

$$δ {λ}_{eff} = \sqrt{{( \frac{\frac{1}{{φ}_{PM 2.5 , z}} ( \frac{{\dot{\tilde{v}}}_{m}}{{\dot{\tilde{v}}}_{oa}} + 1 )}{{( \frac{{φ}_{PM 2.5 , OA}}{{φ}_{PM 2.5 , z}} + \frac{{\dot{\tilde{v}}}_{m}}{{\dot{\tilde{v}}}_{oa}} )}^{2}} \cdot {δφ}_{PM 2.5 , O A} )}^{2} + {( \frac{- \frac{{φ}_{PM 2.5 , OA}}{{{φ}_{PM 2.5 , z}}^{2}} ( \frac{{\dot{\tilde{v}}}_{m}}{{\dot{\tilde{v}}}_{oa}} + 1 )}{{( \frac{{φ}_{PM 2.5 , OA}}{{φ}_{PM 2.5 , z}} + \frac{{\dot{\tilde{v}}}_{m}}{{\dot{\tilde{v}}}_{oa}} )}^{2}} \cdot {δφ}_{PM 2.5 , z} )}^{2}} = \frac{( \frac{{\dot{\tilde{v}}}_{m}}{{\dot{\tilde{v}}}_{oa}} + 1 ) \sqrt{{{δφ}_{PM 2.5 , O A}}^{2} + {( \frac{{φ}_{PM 2.5 , OA}}{{φ}_{PM 2.5 , z}} {δφ}_{PM 2.5 , z} )}^{2}}}{{{φ}_{PM 2.5 , z} ( \frac{{φ}_{PM 2.5 , OA}}{{φ}_{PM 2.5 , z}} + \frac{{\dot{\tilde{v}}}_{m}}{{\dot{\tilde{v}}}_{oa}} )}^{2}} \qquad [ 9 ]$$

The uncertainty of the indoor air PM2.5 concentration φ_{PM2.5,z} and the outdoor air PM2.5 concentration φ_{PM2.5,OA} is attributable to the sensors used to measure these values. The following table lists the measurement ranges and uncertainties for several types of suitable PM2.5 sensors. In this table, “MV” stands for a measurement value. AHU controller 230 can obtain measurements of the indoor air PM2.5 concentration φ_{PM2.5,z} and the outdoor air PM2.5 concentration φ_{PM2.5,OA} from sensors 318 (or any other data source), determine the uncertainties of these values based on the corresponding sensor type using the table below, and calculate the uncertainty of the effective filter efficiency δλ_{eff} using equation 9. AHU controller 230 can repeat this process for each time step included in the weighted average to determine a corresponding uncertainty of the effective filter efficiency δλ_{eff} at that time step.

| Sensor Type | Range | Uncertainty | |
|---|---|---|---|
| Type A | 0-2000 μg/m³ | ±1.3 μg/m³ | |
| Type B | 0-1000 μg/m3 | In range 0-30 μg/m³ | ±1.3 μg/m³ |
| | | In range 30-1000 | 10% MV |
| | | μg/m³ | |
| Type C | 0-500 μg/m3 | In range 0-150 g/m³ | ±5 μg/m³ + 15% |
| | | | MV |
| | | In range 150-500 | ±5 μg/m³ + 20% |
| | | μg/m³ | MV |

AHU controller 230 can be configured to assign weights to each of the effective filter efficiency values Neff based on their corresponding uncertainties δλ_{eff}. For example, AHU controller 230 can assign a first weight w[1] to a first value λ_{eff}[1] of the effective filter efficiency for time step t[1] based on the uncertainty δλ_{eff}[1] at that same time step. This can be repeated for each time step. In some embodiments AHU controller 230 calculates the weight for each time step as the reciprocal of the uncertainty squared for that time step as shown in equation 10.

$$w [ i ] = \frac{1}{δ {λ}_{eff}^{2} [ i ]} \qquad [ 10 ]$$

where w[i] is the weight for time step t[i] and δλ_{eff}²[i] is the square of the uncertainty value for that same time step. Accordingly, the weights w will be relatively higher for time steps when the effective filter uncertainties δλ_{eff} are high, whereas the weights w will be relatively lower for time steps when the effective filter uncertainties δλ_{eff} are low. This means high uncertainty values δλ_{eff} will cause the corresponding values of effective filter efficiency λ_{eff} to have little impact on filter efficiency calculation.

AHU controller 230 can calculate the overall effective filter efficiency λ_{eff,overall} using a weighted average of the effective filter efficiencies λ_{eff}[i] at each time step and the corresponding weight values w[i] as shown in equation 11:

$${λ}_{eff , overall} = \frac{{\sum }_{i = 1}^{n} w [ i ] \cdot {λ}_{eff} [ i ]}{{\sum }_{i = 1}^{n} w [ i ]} = \frac{{\sum }_{i = 1}^{n} ( w [ i ] \cdot \frac{\frac{{φ}_{PM 2.5 , OA} [ i ]}{{φ}_{PM 2.5 , z} [ i ]} - 1}{\frac{{φ}_{PM 2.5 , OA} [ i ]}{{φ}_{PM 2.5 , z} [ i ]} + \frac{{\dot{\tilde{v}}}_{m}}{{\dot{\tilde{v}}}_{oa}}} )}{{\sum }_{i = 1}^{n} w [ i ]} \qquad [ 11 ]$$

In some embodiments, AHU controller 230 pre-filters the timeseries of effective efficiency values λ_{eff}[i] to remove erroneous data or assigns such timeseries values a weight of zero. For example, AHU controller 230 can remove or assign zero weight to any timeseries values where the corresponding weight w[i] is not a number (NAN), the value of the effective filter efficiency λ_{eff}[i] is NAN or less than zero, and/or when the time step is within a time period during which the building zone is not occupied. AHU controller 230 can use occupancy data for the building zone (e.g., measurements from occupancy sensors, an occupancy schedule, etc.) to identify the particular time steps or time periods during which the building zone is not occupied.

### Testing Results

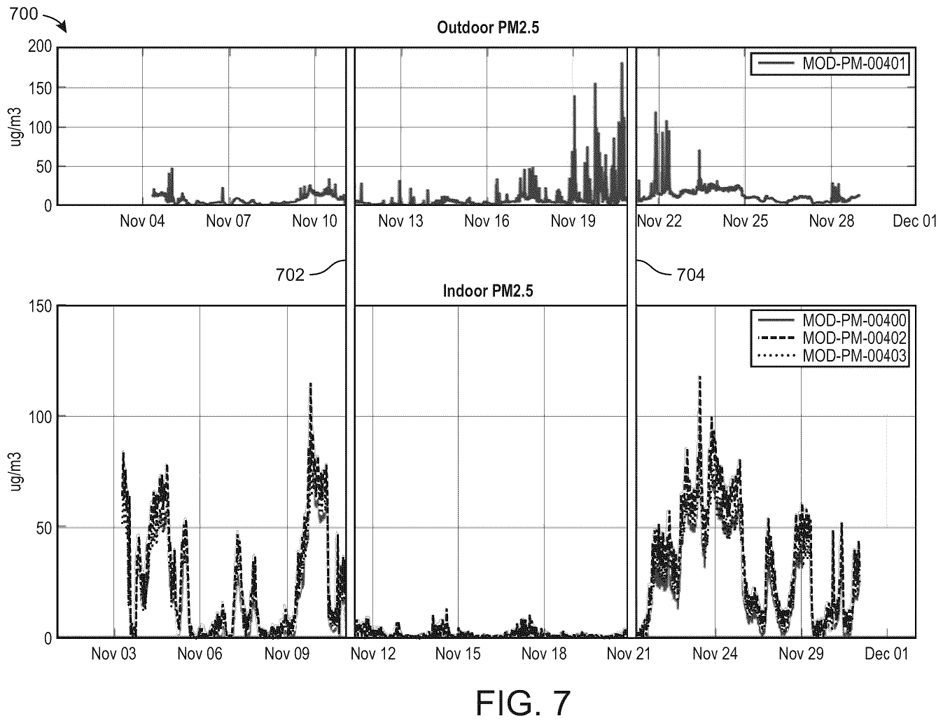

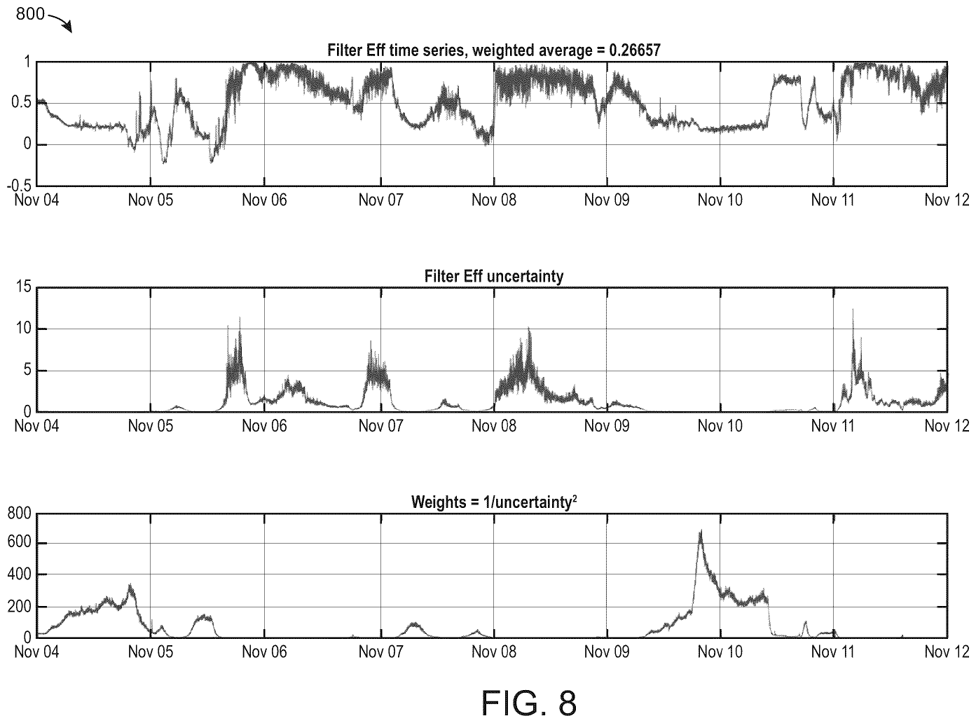

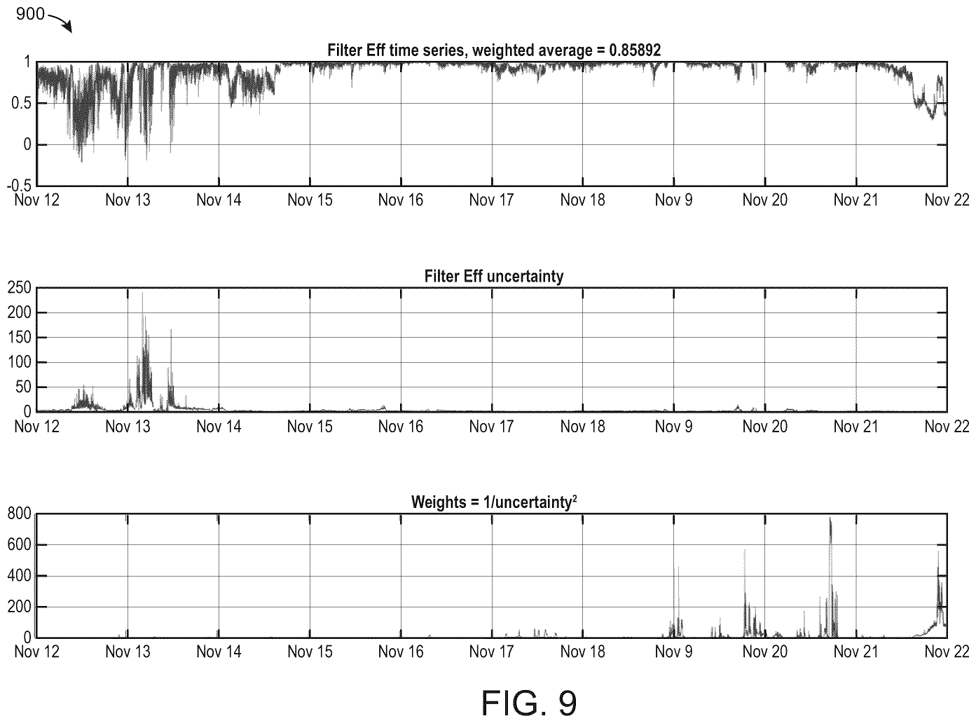

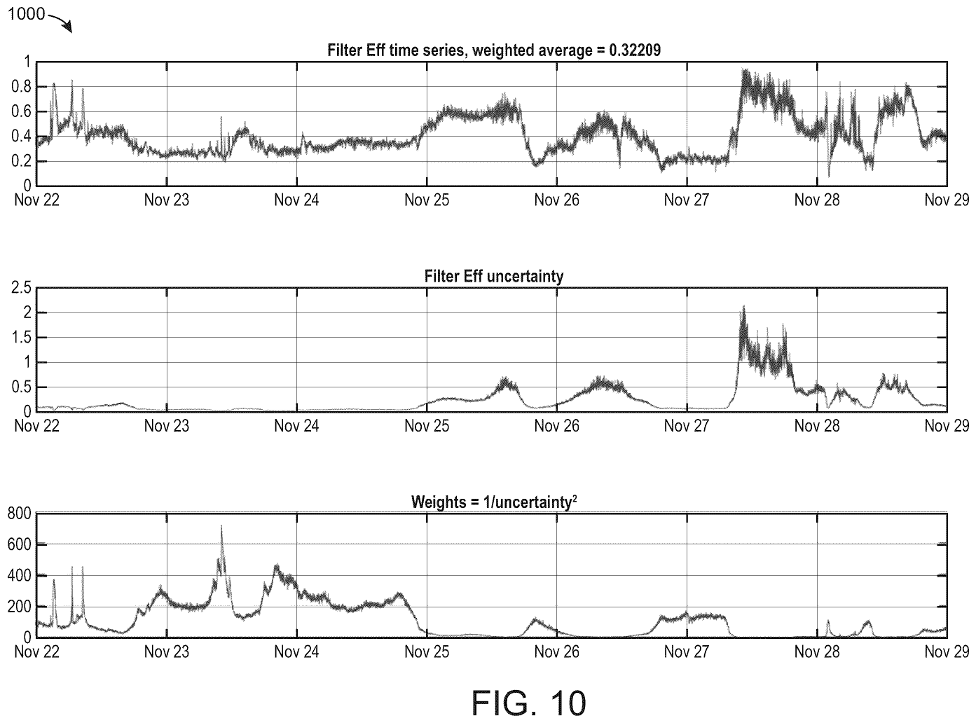

Referring now to FIGS. 7-10, several graphs 700-1000 illustrating testing conducted to verify the correctness of the effective filter efficiency calculations are shown. Graph 700 shows that the test has three time periods separated by the boundary lines 702 and 704. During the first time period before November 12^{th} (i.e., to the left of boundary line 702) and during the third time period after November 21^{st} (i.e., to the right of boundary line 704), the in-zone filter remained off. However, during the second time period between November 12^{th} and November 21^{st} (i.e., between boundary lines 702 and 704), the in-zone filter was turned on to provide additional filtration within the building zone. The upper plot shows the outdoor PM2.5 and the lower plot shows three indoor PM 2.5 measurements. The three indoor PM2.5 measurements follow the same trend. During the time period between boundary line 702 and 704 the indoor PM2.5 is significantly reduced though there is no significant change to the occupant behavior or outdoor PM2.5, showing the effectiveness of in-zone filtration if PM2.5 generation is high or outdoor air concentration is high.

Graph 800 corresponds to the first time period in graph 700 and shows detailed time series calculation of filter efficiency λ_{eff}[i], uncertainty δλ_{eff}[i], and weights w[i] at each time step within the first time period. The estimated overall effective filter efficiency λ_{eff,overall} of the first time period is 0.26657. Similarly, graphs 900 and 1000 illustrate the testing results for second and third time periods in graph 700, respectively. When the in-zone filter was turned on during the second time period shown in graph 900, the estimated overall effective filter efficiency λ_{eff,overall} increased to 0.85892. When the in-zone filter was turned off again during the third time period shown in graph 1000, the overall effective filter efficiency λ_{eff,overall} dropped to 0.32209 during the third time period. It is noted, that the effective filter efficiency is much higher during the time period when the in zone filtration is on.

### Indoor PM2.5 Generation Detection

While the discussion herein describes AHU controller 230 as calculating the indoor PM2.5 generation, it is contemplated that either the AHU controller 230, the remote analysis system, or both could calculate the indoor PM2.5 generation.

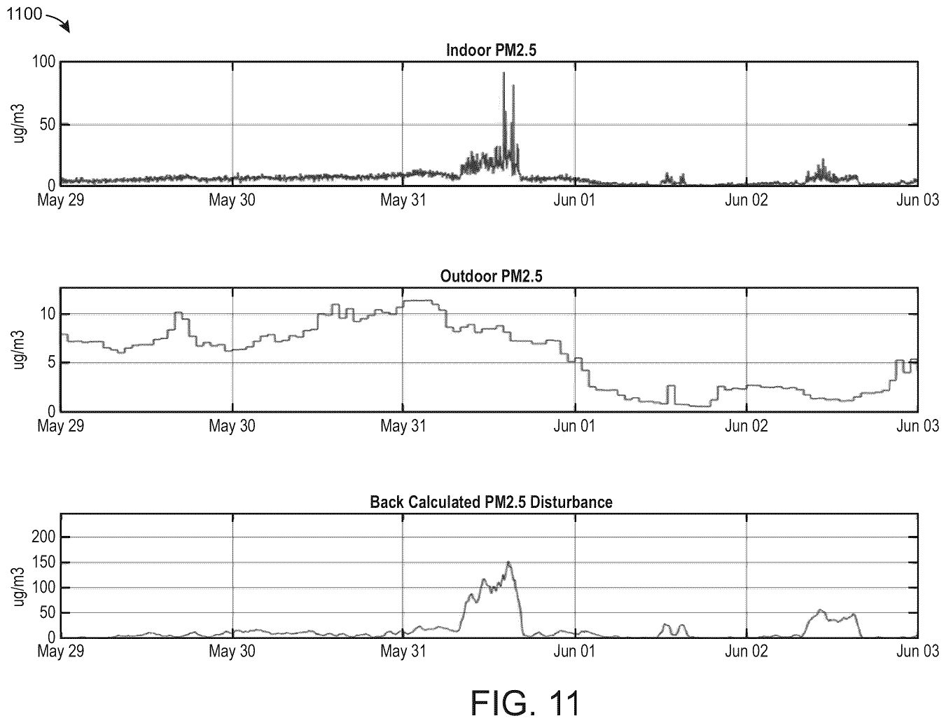

Referring now to FIGS. 11-13, AHU controller 230 can be configured to identify time periods during which indoor PM2.5 generation (i.e., the PM2.5 disturbance \dot{φ}_{PM2.5,dist}) is elevated. As described above, the effective filter efficiency calculation shown in equation 7 assumes no PM2.5 disturbance \dot{φ}_{PM2.5,dist}. However, if the PM2.5 disturbance \dot{φ}_{PM2.5,dist} actually exists and is not accounted for, the calculated values of effective filter efficiency λ_{eff} significantly underestimate the actual filter efficiency λ_{HVAC} because the PM2.5 disturbance \dot{φ}_{PM2.5,dist} is making the air filter appear less effective than it actually is. Accordingly, finding the periods of indoor PM2.5 generation may further improve the accuracy of efficiency estimation.

AHU controller 230 can estimate the PM2.5 disturbance \dot{φ}_{PM2.5,dist} at each time step using equation 12:

$${\dot{φ}}_{PM 2.5 , dist} [ n ] = \frac{( {\dot{\tilde{v}}}_{oa} + {\dot{\tilde{v}}}_{m} {λ}_{PM 2.5} ) {φ}_{PM 2.5 , z} [ n + 1 ] - {\dot{\tilde{v}}}_{oa} ( 1 - {λ}_{PM 2.5} ) {φ}_{PM 2.5 , OA} [ n ]}{1 - {e}^{- ( {\dot{\tilde{v}}}_{oa} + {\dot{\tilde{v}}}_{m} {λ}_{PM 2.5} ) Δ}} - \frac{{e}^{- ( {\dot{\tilde{v}}}_{oa} + {\dot{\tilde{v}}}_{m} {λ}_{PM 2.5} ) Δ} ( ( {\dot{\tilde{v}}}_{oa} + {\dot{\tilde{v}}}_{m} {λ}_{PM 2.5} ) {φ}_{PM 2.5 , z} [ n ] - {\dot{\tilde{v}}}_{oa} ( 1 - {λ}_{PM 2.5} ) {φ}_{PM 2.5 , OA} [ n ] )}{1 - {e}^{- ( {\dot{\tilde{v}}}_{oa} + {\dot{\tilde{v}}}_{m} {λ}_{PM 2.5} ) Δ}} \qquad [ 12 ]$$

which is plotted in graph 1100 as the back calculated PM2.5 disturbance \dot{φ}_{PM2.5,dist} (bottom plot). In equation 12, λ_{PM2.5} is the filter efficiency of removing PM2.5 which can either be a manufacturer value or the effective efficiency as described previously. It is noted that if the effective efficiency is used, an iterative approach may be beneficial, wherein the filter efficiency is calculated assuming there is no PM2.5 generation, then PM2.5 generation is estimated using the calculated filter efficiency, times of elevated PM2.5 generation are removed, estimation of the filter efficiency is repeated until there is no change. The high value of indoor PM2.5 on May 31 is due to the PM2.5 disturbance \dot{φ}_{PM2.5,dist}. For example, painting or some other activity in the building zone may function as a PM2.5 disturbance \dot{φ}_{PM2.5,dist} which generates PM2.5 within the building zone and causes the indoor air PM2.5 concentration \dot{φ}_{PM2.5,z} to increase (top plot). A PM2.5 disturbance threshold can be used to locate the PM2.5 generation period accurately.

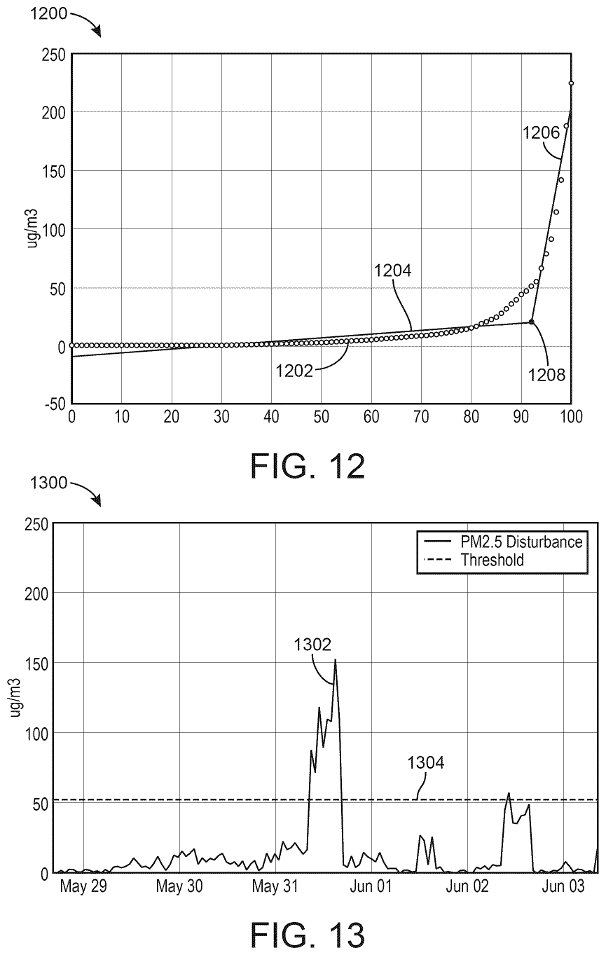

Graph 1200 of FIG. 12 illustrates how the PM2.5 disturbance threshold can be calculated. The AHU controller 230 may calculate the generation of PM2.5 (e.g., the y-axis) for a number of time periods (e.g., between one or more samples as indicated by equation 12). The AHU controller 230 can calculate the 1st to 100th percentile of PM2.5 disturbance, shown as the circles 1202 in graph 1200. AHU controller 230 may then run piecewise linear regression of the percentile data to generate piecewise regression lines 1204 and 1206. In the piecewise linear regression, the break point (e.g., the percentile or x-coordinate value where the two lines of the piecewise linear function join) may be a free parameter. For example, nonlinear regression can be performed, or a sequence of linear regressions can be performed where the break point is assumed to be a particular value. The assumed break point that is associated with the best fitting linear regression is then chosen. The best break point can be found, for example, by an exhaustive search or advantageously single variable optimization techniques (e.g., a golden section search). AHU controller 230 may find the junction point 1208 between the two regression lines 1204 and 1206 and use the junction point 1208 as the threshold of PM2.5 disturbance \dot{φ}_{PM2.5,dist}. In particular, the y-coordinate value of the junction point 1208 can be used as the threshold of PM2.5 disturbance \dot{φ}_{PM2.5,dist}.

Graph 1300 of FIG. 13 illustrates the PM2.5 disturbance \dot{φ}_{PM2.5,dist} 1302 and the corresponding threshold 1304 found using the piecewise regression technique illustrated in FIG. 12. Any period when the PM2.5 disturbance \dot{φ}_{PM2.5,dist} is higher than the threshold will be considered a PM2.5 generation period. The PM2.5 disturbance calculated from equation 12 may be subject to noise. To make this detection algorithm more reliable, additional steps can be used. For example, the AHU controller may determine if the threshold 1304 was exceeded for a duration greater than a time period threshold (e.g., greater than a half hour) to be considered a PM2.5 generation period. Additionally, any short time periods (e.g., less than an hour or half hour) that would otherwise qualify as a non-PM2.5-generation period but are surrounded by valid PM2.5 generation periods can be changed to PM 2.5 generation periods. After the PM2.5 generation periods are found, the effective filter efficiency λ_{eff} can be re-calculated. The updated effective filter efficiency λ_{eff} will not depend on the PM2.5 ratios during the PM2.5 generation periods. In this way, the updated filter efficiency Neff values will always be greater than or equal to the original filter efficiency λ_{eff} values.

### Action Suggestion and Execution

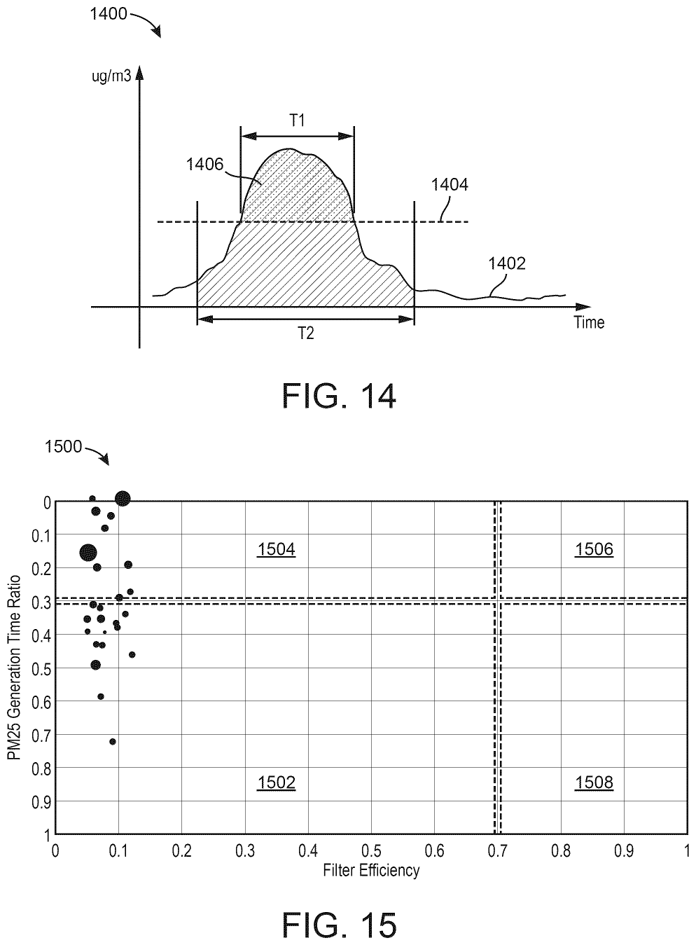

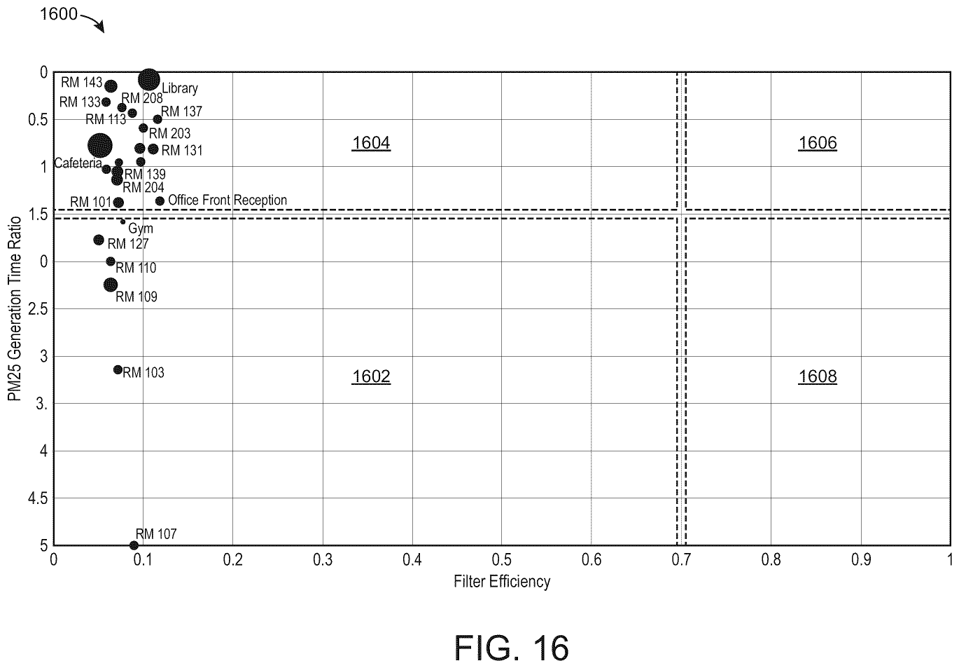

Referring now to FIGS. 14-16, several graphs 1400-1600 illustrating actions suggested or automatically executed by AHU controller 230 or the remote analysis system as a result of the filter efficiency estimation and PM2.5 generation detection are shown. The result of filter efficiency estimation and PM2.5 generation detection gives enough data to provide suggestions to improve air quality. In some embodiments, AHU controller 230 suggests particular actions using the quadrant graphs 1500 and 1600 as shown in FIGS. 15 and 16, which separates the axis into four regions. Each of the four regions in graphs 1500 and 1600 represents different action suggestion. The x-axis is the effective filter efficiency, and the y-axis is the PM2.5 generation time ratio.

Two ways of calculating the PM2.5 generation time ratio are shown in FIG. 14. The curve 1402 is the PM2.5 disturbance \dot{φ}_{PM2.5,dist}, the dash line 1404 is the PM2.5 generation period threshold, T1 is the PM2.5 generation period, and T2 is the occupied period. A first method for calculating the PM2.5 generation time ratio is using the area of the portion 1406 of the shaded region above the threshold line 1404 (shaded blue in graph 1400) over the entire area of the shaded region (both above and below the threshold line 1404). The first method is expressed mathematically in equation 13:

$$R = \frac{{\sum }_{i = 1}^{m} max ( {\dot{φ}}_{PM 2.5 , dist} [ i ] \cdot t [ i ] - Threshold , 0 )}{{\sum }_{j = 1}^{n} ( {\dot{φ}}_{PM 2.5 , dist} [ j ] \cdot t [ j ] )} \qquad [ 13 ]$$

where R is the PM2.5 generation time ratio (unitless), m is all the detected PM2.5 generation periods, n is all the occupied periods. The physical meaning of the first method is to find the percent of generated indoor PM2.5 amount over indoor PM2.5 during the occupied period. The result is normalized between 0 to 1.

A second method for calculating the PM2.5 generation time ratio is using the area in shaded portion 1406 over the duration T2 as expressed in equation 14:

$$R = \frac{{\sum }_{i = 1}^{m} ( {\dot{φ}}_{PM 2.5 , dist} [ i ] \cdot t [ i ] - Threshold )}{{\sum }_{j = 1}^{n} t [ j ]} \qquad [ 14 ]$$

The physical meaning of the second method is the average amount of generated indoor PM2.5 during the occupied period. AHU controller 230 may use the same threshold to calculate the PM2.5 generation time ratio for all the zones for a consistent comparison. The same threshold can be found using the mean/median value of all the individual zone's threshold, or a specific value defined by an expert. Once the values of the PM2.5 generation time ratio are obtained, graphs 1500 and 1600 can be used to determine the recommended action.

FIG. 15 shows the action plot 1500 generated using school data. The PM2.5 generation time ratio R (y-axis) is calculated using the first method described above. The median value of all the zone's PM2.5 generation thresholds is used as the common threshold. In FIG. 15, the region 1506 has a high filter efficiency and a low PM2.5 generation time ratio. Any zone in this region has good indoor air quality, and therefore AHU controller 230 or remote analysis system may determine that no action is needed for zones in region 1506. The region 1504 has a low HVAC filter efficiency and a low PM2.5 generation, and therefore AHU controller 230 or remote analysis system may suggest upgrading the HVAC filter for zones in region 1504. The region 1502 has a low filter efficiency but a high PM2.5 generation, and therefore AHU controller 230 or remote analysis system may recommend both an HVAC filter upgrade and in-zone filtration for zones located in region 1502. Finally, the region 1508 has a high HVAC filter efficiency and a high PM2.5 generation, and therefore AHU controller 230 or remote analysis system may suggest using an in-zone filter for any zones in region 1508. Upgrading the HVAC filter may include replacing the HVAC filter with a more efficient or effective model or type of air filter, replacing the HVAC filter with an identical but newer HVAC filter (e.g., an unused HVAC filter of the same model or type), or otherwise making changes to the HVAC filter that improve the HVAC filtration efficiency.

Graph 1600 shown in FIG. 16 is similar to graph 1500 shown in FIG. 15 with regions 1602-1608 that correspond to regions 1502-1508, respectively. The only difference is FIG. 16 uses the second method described above to calculate the PM2.5 generation time ratio R. In some embodiments, AHU controller 230 or remote analysis system can automatically initiate the recommended actions. For example, AHU controller 230 or remote analysis system can provide a control signal to in-zone filtration to active or deactivate the in-zone filtration or to cause in-zone filtration units to be purchased (e.g., by creating and sending a work order to a service technician and/or creating a purchase order). AHU controller 230 or remote analysis system can automatically cause the existing air filter within AHU 400 to be replaced or upgraded (e.g., by creating and sending a work order to a service technician, by automatically ordering a new filter, by operating equipment that swaps out the existing air filter with a new filter, etc.). All such embodiments are within the scope of the present disclosure.

### Flows of Operation

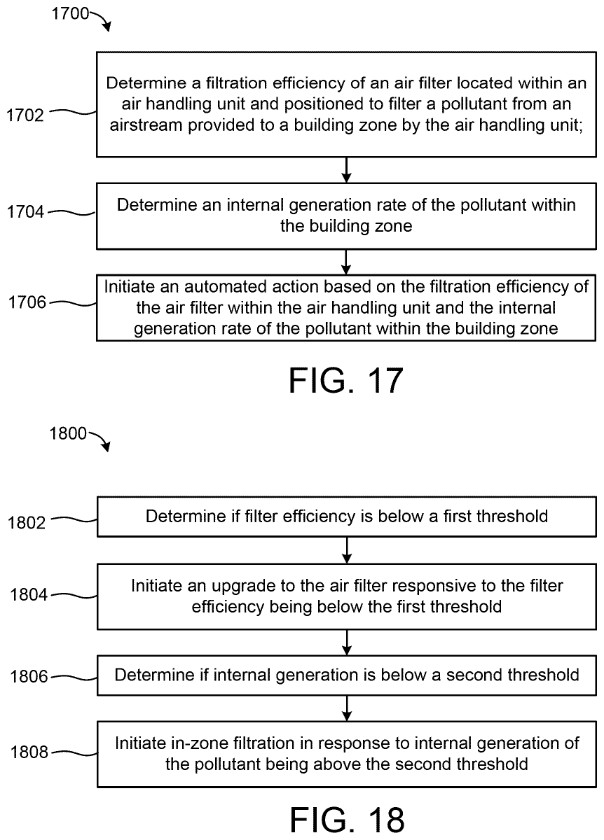

FIGS. 17-20 are flows of operations describing methods that a computer system (e.g., the AHU controller 230 or the remote operations system) may perform to achieve the functionality described herein.

FIG. 17 shows flow of operations 1700 for initiating an automated action based on a filtration efficiency of an air filter and an internal generation rate of a pollutant within a building zone, according to some embodiments. Flow 1700 may include determine a filtration efficiency of an air filter located within an air handling unit and positioned to filter a pollutant from an airstream provided to a building zone by the air handling unit in operation 1702. For example, equation 7 can be used to determine an effective filtration efficiency based on a ration between indoor and outdoor measurements of a pollutant. In some embodiments, there is uncertainty associated with any one calculation of the filtration efficiency and a weighted average of multiple filtration efficiency calculations can advantageously reduce the level of uncertainty. Equation 8 and/or 9 can be used to calculate an uncertainty and in turn determine a weight for that particular estimate when calculating the weighted average.

In some embodiments, flow 1700 includes determining an internal generation rate of the pollutant within the building zone. For example, equation 12 can be used to determine an internal generation rate of the pollutant using time adjacent measurements of the concentration of the pollutant within the zone. In some embodiments, it may be desired to find only time periods of significant pollutant generation (e.g., to determine when in-zone filtration should run). A threshold may be determined indicative of significant pollutant generation and the estimated internal generation rate can be compared to the threshold. The techniques described with reference to FIGS. 12 and 13 may be used.

In some embodiments, flow 1700 includes initiating an automated action based on the filtration efficiency of the air filter within the air handling unit and the internal generation rate of the pollutant within the building zone in operation 1706. For example, the techniques described in the action suggestion and execution section can be performed. Initiating in-zone filtration or the purchase of new or additional in-zone filtration may depend on a comparison of the ratio of time periods for which there is significant pollutant generation to a threshold. A small number of periods or amount of time (e.g., less than 25% or less than 35%), may indicate that no additional in-zone filtration is required (e.g., the AHU filter can effectively remove the generated pollutant). However, if the ratio of time is greater than the defined threshold in-zone filtration may be appropriate. Initiating a filter replacement and/or filter upgrade may depend on a comparison of the calculated filter efficiency and/or the uncertainty therein. For example, if the filter efficiency is less than 70% a filter upgrade may be appropriate. In some embodiments, initiating a filter upgrade or replacement (e.g., creating the work order or purchase order) is also based on the average value of the indoor pollutant concentration (e.g., even if the filters are not that efficient, if pollutant levels remain low because of good quality outdoor air or low levels of indoor generation, there may not be sufficient reason to upgrade the filter).

FIG. 18. shows flow of operations 1800 for determining the automated action based on a filtration efficiency of an air filter and an internal generation rate of a pollutant within a building zone, according to some embodiments. Flow of operations 1800 may be a more detailed version of operation 1706, according to some embodiments. The flow 1800 may include determining if the filter efficiency is below a first threshold (e.g., a predetermined threshold of 50%, 70%, etc.) in operation 1802. In some embodiments, the threshold may depend on the uncertainty in the estimate of the filter efficiency, the average concentration of the pollutant within the zone, etc. In operation 1804 an upgrade to the air filter may be initiated in response to the filter efficiency being below the first threshold.

In some embodiments, flow 1800 includes determining if the internal generation is below a second threshold in operation 1806. The internal generation, for example, can be represented by the ratio of the amount of time for which it is determined that there is significant generation or the internal generation can be represented by the average generation (e.g., during occupied hours) as described by equations 13 and 14, respectively. In operation 1808 in-zone filtration may be initiated in response to the internal generation (or its representation) of the pollutant being above the second threshold.

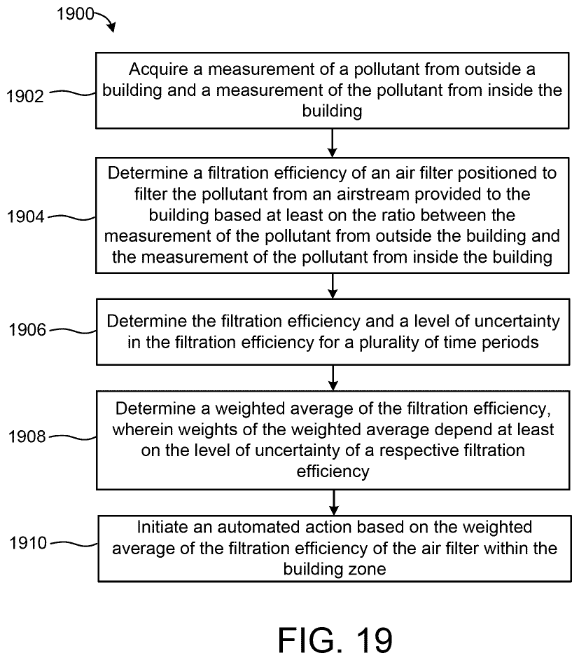

FIG. 19 shows flow of operations 1900 for estimating a filter efficiency and initiating an automated action based on the efficiency, according to some embodiments. Various operations in flow 1900 may be used to perform operation 1702 in some embodiments. Flow 1900 may include acquiring a measurement of a pollutant from outside a building and a measurement of the pollutant from inside the building in operation 1902. In some embodiments, a timeseries of both or either of the measurements is acquired (e.g., to provide additional measurements and greater confidence in the conclusions drawn therefrom).

Flow 1900 may include determining a filtration efficiency of an air filter positioned to filter the pollutant from an airstream provided to the building based at least on the ratio between the measurement of the pollutant from outside the building and the measurement of the pollutant from inside the building in step 1904. For example, equation 7 can be used with an assumed value for the ratio mixed air to outdoor air. It is noted that (i) from FIGS. 5 and 6 this ratio does not have a large effect on the estimated filter efficiency and (ii) typically values for this ratio within a building are between four and six; thus, if the true ratio is not known a typical value (e.g., five) can be chosen.

In some embodiments, flow 1900 includes determining the filtration efficiency and a level of uncertainty in the filtration efficiency for a plurality of time periods (e.g., a day, a week, a month, etc.) in operation 1906. The uncertainty can be calculated, for example, using equations 8 and/or 9 described herein. Flow 1900 may include determining a weighted average of the filtration efficiency, wherein weights of the weighted average depend at least on the level of uncertainty of a respective filtration efficiency in operation 1908. Advantageously, this causes the estimates of the filter efficiency to be weighted more heavily when the uncertainty is low. It is noted that when outdoor air quality is high (e.g., less than 10 μg/m³), the uncertainty in the filter estimate is high because the uncertainty in the measurement of the indoor concentration levels can have a large effected on the calculated ratio. For example, with an outdoor measurement of 10 μg/m³ the ratio will change from 10 to 5 based on a fluctuation of the indoor concentration between 1 and 2 μg/m³.

In some embodiments, flow 1900 includes initiating an automated action based on the weighted average of filtration efficiency operation 1908. Initiating a filter replacement and/or filter upgrade may depend on a comparison of the calculated filter efficiency and/or the uncertainty therein. For example, if the filter efficiency is less than 70% a filter upgrade may be appropriate. In some embodiments, initiating a filter upgrade or replacement (e.g., creating the work order or purchase order) is also based on the average value of the indoor pollutant concentration (e.g., even if the filters are not that efficient, if pollutant levels remain low because of good quality outdoor air or low levels of indoor generation, there may not be sufficient reason to upgrade the filter).

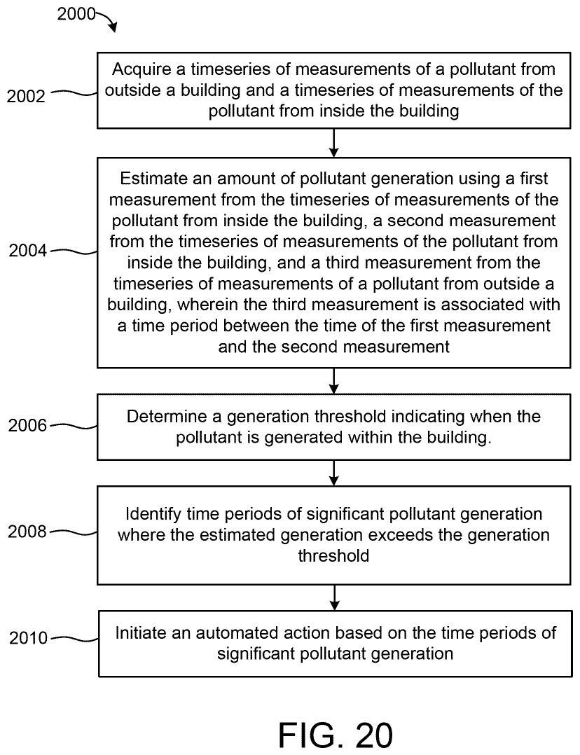

FIG. 20 shows flow of operations 2000 for identifying time periods of significant indoor pollutant generation and initiating an automated action based on the time periods of generation, according to some embodiments. Flow 2000 may include acquiring a timeseries of measurements of a pollutant from outside a building and a timeseries of measurements of the pollutant from inside the building in operation 2002. In some embodiments, flow 2000 includes estimating an amount of pollutant generation using a first measurement from the timeseries of measurements of the pollutant from inside the building, a second measurement from the timeseries of measurements of the pollutant from inside the building, and a third measurement from the timeseries of measurements of a pollutant from outside a building, wherein the third measurement is associated with a time period between the time of the first measurement and the second measurement in operation 2004. For example, equation 12 can be used to perform operation 2004. It is contemplated that any sampling rate can be used in the calculation of equation 12. If measurements are acquired every 5 minutes calculations can be performed on every third sample (e.g., using data sampled 15 minutes apart). Advantageously, this limits the amount of processing that is required and can reduce noise in the calculation by taking the difference between two samples over a longer time period.

Flow 2000 may include determining a generation threshold indicating when the pollutant is generated within the building in operation 2006. Generation thresholds may be obtained using the discussion with reference to FIG. 12. The generation of the pollutant for a number of time periods can be calculated. Data points can be developed that relate a percentile of estimated pollutant generation to the amount of pollutant generation. For example, the 50th percentile may correspond to 30 μg/m³s meaning that 50% of the estimated pollutant generation amounts are less than 30 μg/m³s. Piecewise linear regression can be performed on the percentile data to generate a model fit with a single break point (e.g., the percentile value where the two lines of the piecewise linear function join) may be a free parameter. For example, nonlinear regression can be performed, or a sequence of linear regressions can be performed where the break point is assumed to be a particular value. The assumed break point that is associated with the best fitting linear regression is then chosen. The best break point can be found, for example, by an exhaustive search or advantageously single variable optimization techniques (e.g., a golden section search). The break point or junction point may be used as the threshold in operation 2008.

In some embodiments, flow 2000 includes identifying time periods of significant pollutant generation where the estimated generation exceeds the generation threshold in operation 2008. To make this detection algorithm more reliable, additional steps may be used. For example, a minimum duration may limit the number of time periods that are considered time periods of significant generation. Additionally or alternatively, any short time periods (e.g., less than an hour or half hour) that would otherwise qualify as a non-generation period but are surrounded by valid time periods of significant pollutant generation periods can be changed to time periods of significant pollutant generation. Flow 2000 may include initiating an automated action based on the time periods of significant pollutant generation in operation 2010. For example, the ratio of the amount of time for which it is determined that there is significant generation or the average generation (e.g., during occupied hours) can be calculated as described by equations 13 and 14, respectively, and compared to a second threshold to determine if an action should be taken. In some embodiments, in-zone filtration may be initiated in response to the ratio exceeding the second threshold.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A building system comprising one or more processors and one or more non-transitory computer-readable media storing instructions that, when executed by the one or more processors, cause the one or more processors to perform operations comprising:
determining a filtration efficiency of an air filter located within an air handling unit, wherein the air filter is positioned to filter a pollutant from an airstream provided to a building zone by the air handling unit;
determining an internal generation rate of the pollutant within the building zone; and
initiating an automated action based on the filtration efficiency of the air filter within the air handling unit and the internal generation rate of the pollutant within the building zone.

2. The building system of claim 1, wherein determining the filtration efficiency of the air filter within the air handling unit comprises:
obtaining a first ratio of outdoor air pollutant concentration outside a building to indoor air pollutant concentration within the building zone;
obtaining a second ratio of recirculation air flow rate from the building zone to outdoor air flow rate from outside the building; and
using the first ratio and the second ratio to calculate the filtration efficiency of the air filter.

3. The building system of claim 1, wherein determining the filtration efficiency of the air filter within the air handling unit comprises calculating a weighted average of a plurality of values of the filtration efficiency for a plurality of time steps.

4. The building system of claim 3, wherein calculating the weighted average of the plurality of values of the filtration efficiency comprises:
determining a plurality of values of uncertainty corresponding to the plurality of values of the filtration efficiency at the plurality of time steps; and
assigning weights to the plurality of values of the filtration efficiency in the weighted average based on the corresponding values of the uncertainty at the plurality of time steps.

5. The building system of claim 1, wherein determining the internal generation rate of the pollutant within the building zone comprises calculating a pollutant generation time ratio based on a plurality of values of the internal generation rate of the pollutant within the building zone at a plurality of time steps.

6. The building system of claim 5, wherein calculating the pollutant generation time ratio comprises determining at least one of:
a percentage of the pollutant generated within the building zone during occupied time periods; or
an average amount of the pollutant generated within the building zone during occupied time periods.

7. The building system of claim 1, wherein the automated action comprises causing or recommending an upgrade to the air filter within the air handling unit in response to determining that:
the filtration efficiency of the air filter is below a first threshold; and
the internal generation rate of the pollutant within the building zone is below a second threshold.

8. The building system of claim 1, wherein the automated action comprises activating or recommending activation of in-zone filtration within the building zone in response to determining that:
the filtration efficiency of the air filter is above a first threshold; and
the internal generation rate of the pollutant within the building zone is above a second threshold.

9. The building system of claim 1, wherein the automated action comprises both (i) activating or recommending activation of in-zone filtration within the building zone and (ii) causing or recommending an upgrade to the air filter within the air handling unit in response to determining that:
the filtration efficiency of the air filter is below a first threshold; and
the internal generation rate of the pollutant within the building zone is above a second threshold.

10. A method of operating air filtration equipment comprising an air filter positioned to filter a pollutant from an airstream provided to a building zone of a building by an air handling unit, the method comprising:
determining a filtration efficiency of the air filter;
determining an internal generation rate of the pollutant within the building zone; and
initiating an automated action based on the filtration efficiency of the air filter within the air handling unit and the internal generation rate of the pollutant within the building zone.

11. The method of claim 10, wherein determining the filtration efficiency of the air filter within the air handling unit comprises:
obtaining a first ratio of outdoor air pollutant concentration outside the building to indoor air pollutant concentration within the building zone;
obtaining a second ratio of recirculation air flow rate from the building zone to outdoor air flow rate from outside the building; and
using the first ratio and the second ratio to calculate the filtration efficiency of the air filter.

12. The method of claim 10, wherein determining the filtration efficiency of the air filter within the air handling unit comprises calculating a weighted average of a plurality of values of the filtration efficiency for a plurality of time steps.

13. The method of claim 12, wherein calculating the weighted average of the plurality of values of the filtration efficiency comprises:
determining a plurality of values of uncertainty corresponding to the plurality of values of the filtration efficiency at the plurality of time steps; and
assigning weights to the plurality of values of the filtration efficiency in the weighted average based on the corresponding values of the uncertainty at the plurality of time steps.

14. The method of claim 10, wherein determining the internal generation rate of the pollutant within the building zone comprises calculating a pollutant generation time ratio based on a plurality of values of the internal generation rate of the pollutant within the building zone at a plurality of time steps.

15. The method of claim 14, wherein calculating the pollutant generation time ratio comprises determining at least one of:
a percentage of the pollutant generated within the building zone during occupied time periods; or
an average amount of the pollutant generated within the building zone during occupied time periods.

16. The method of claim 10, wherein the automated action comprises causing or recommending an upgrade to the air filter within the air handling unit in response to determining that:
the filtration efficiency of the air filter is below a first threshold; and
the internal generation rate of the pollutant within the building zone is below a second threshold.

17. The method of claim 10, wherein the automated action comprises activating or recommending activation of in-zone filtration within the building zone in response to determining that:
the filtration efficiency of the air filter is above a first threshold; and
the internal generation rate of the pollutant within the building zone is above a second threshold.

18. The method of claim 10, wherein the automated action comprises both (i) activating or recommending activation of in-zone filtration within the building zone and (ii) causing or recommending an upgrade to the air filter within the air handling unit in response to determining that:
the filtration efficiency of the air filter is below a first threshold; and
the internal generation rate of the pollutant within the building zone is above a second threshold.

19. The method of claim 10, wherein the automated action comprises informing a user that no action is needed in response to determining that:
the filtration efficiency of the air filter is above a first threshold; and
the internal generation rate of the pollutant within the building zone is below a second threshold.

20. One or more processors and one or more non-transitory computer-readable media storing instructions that, when executed by the one or more processors, cause the one or more processors to perform operations comprising:
acquiring a measurement of a pollutant from outside a building and a measurement of the pollutant from inside the building;
determining a filtration efficiency of an air filter positioned to filter the pollutant from an airstream provided to the building based at least on a ratio between the measurement of the pollutant from outside the building and the measurement of the pollutant from inside the building;
determining the filtration efficiency and a level of uncertainty in the filtration efficiency for a plurality of time periods;
determining a weighted average of the filtration efficiency, wherein weights of the weighted average depend at least on the level of uncertainty of a respective filtration efficiency; and
initiating an automated action based on the weighted average of the filtration efficiency of the air filter within the building.
